(19) United States
(12) Patent Application Publication
(10) Pub. No.: US 2011/0196872 A1
(43) Pub. Date: Aug. 11, 2011

(54) Computational Method for Comparing, Classifying, Indexing, and Cataloging of Electronically Stored Linear Information

(75) Inventors: Gregory E. Sims, El Sobrante, CA (US); Sung-Hou Kim, Moraga, CA (US)

(73) Assignee: THE REGENTS OF THE UNIVERSITY OF CALIFORNIA, Oakland, CA (US)

(21) Appl. No.: 13/123,516

(22) PCT Filed: Oct. 9, 2009
(86) PCT No.: PCT/US09/60268

§ 371 Date: Apr. 8, 2011

Related U.S. Application Data
(60) Provisional application No. 61/104,646, filed on Oct. 10, 2008.

(51) Int. Cl. G06F 17/30

(52) U.S. Cl. 707/740; 707/E17.089

(57) ABSTRACT

A computational method and system for the comparison and analysis of different objects of information within a database or collection. All objects are compared in a pair-wise fashion so the relative similarity between each object to every other object in the collection is known. A generalized alignment-free method is described for comparing whole genome (coding and non-coding) DNA sequences is used to investigate the relationship among placental mammalian genomes. Differences in word feature frequency profiles (FFP) are used to derive distance and infer evolutionary relationships.

### RELATED APPLICATIONS

This application is the national phase application of International application number PCT/US2009/060268, filed Oct. 9, 2009, which claims priority to and the benefit of U.S. Provisional Application No. 61/104,646, filed on Oct. 10, 2008, both of which are hereby incorporated by reference in their entirety.

### STATEMENT OF GOVERNMENTAL SUPPORT

This invention was made with government support under Contract No. DE-AC02-05CH11231 awarded by the U.S. Department of Energy and under National Institutes of Health Grant No. 3P50GM062412-0552. The government has certain rights in the invention.

### FIELD OF THE INVENTION

The present invention relates to the field of computer science, and more particularly to a feature frequency based method of comparing and cataloguing electronically stored linear information, where the similarity of databases of information is evaluated based on the comparisons of short overlapping fragments of information (features), and to the proper selection of fragment length for comparison of linear information.

### BACKGROUND OF THE INVENTION

Keyword based information comparison methods are commonly used for comparisons of electronic data. However, keyword based similarity between two comparisons fails to capture the syntax and context in which those keyword usage similarities occur. Using human language as an example, it is possible for two articles to be written on the same subject to contain similar word frequencies if written by two different authors. There may be a common vocabulary, jargon or lingo associated with that particular topic of subject matter. However, it is highly unlikely for two separate authors two possess the same linguistic style and syntax unless a significant portion of one author borrowed material from the author. To compare documents at the level of distinguishing one author from another, differences in style and syntax must be captured.

Several methods exist for relating texts to each other using a keyword vector based system including Caid et al., in U.S. Pat. No. 5,619,709; Weissman et al, in U.S. Pat. No. 6,816,857, and Kasian et al., in publication number WO 2006/133050A2. The present methods differ from the above in the manner in which the linear information is preprocessed and in the manner in which the optimal feature lengths are found. This results in the novel ability to capture the syntactical idiosyncrasies of specific authors as well as the unique vocabularies associated with a certain genre or subject matter, and the ability to compare entire works or digitized data.

### SUMMARY OF THE INVENTION

The present invention provides for a method of text comparison which categorizes texts by syntax and subject matter from the text contents itself, without any additional supervision. The classification itself is based upon word usage frequency, as well as the syntax (or ordering) of words within the text body.

Thus, the present invention provides a computer implemented method for comparing digital linear information. In an exemplary embodiment, the method includes (a) providing a database of information to be compared, where the data is stored in individual objects in a linear form, (b) preprocessing of each object by removing all punctuation and delimiting characters if needed, (c) reducing each object to a linear string of data, (d) applying a sliding window to the string of data to extract and count features of a given length, (e) assembling feature counts within the string of data in a feature frequency profile (FFP), (f) determining the best length feature for comparison, such as by using entropy information contained within the string, from a vocabulary feature profile and/or from a cumulative relative entropy profile, (g) comparing the FFPs of optimal length features using a distance metric, (h) assembling distances between objects into a symmetric pair-wise distance matrix, and (i) visualizing the distance matrix.

The method can be applied to comparing very large genomic sequences. When applied to a biological or genomic sequence, the method further includes the conversion of the sequence to a reduced two letter alphabet for comparison. The method can further include filtering features of low complexity, high frequency and reverse complement matching.

The present invention also provides a system for implementing the method on a computing device for large genome data or large text database. In an exemplary embodiment, the computing device is a multiprocessor computing device. In another embodiment, the vocabulary feature profile and cumulative relative entropy profile are used to determine the best lengths for feature comparison.

The present invention also provides a system for comparing digital linear information. In an exemplary embodiment, the system includes (a) a storage including a set of data items to be related, where each data item includes a plurality of terms, (b) a frame generator conFIG.d to generate a frame that selects a plurality of terms in the data items to associate, (c) a profile generator conFIG.d to generate feature frequency profiles to extract and count features of a given length within the frame, where the profile generator further includes instructions for determination of the best length feature for comparison, (d) a distance processor conFIG.d to compare the optimal best length features and assemble the distances between the objects into a pair-wise distance matrix, and (e) a visualization module to visualize the distance matrix. The system can be housed and implemented on a computing device, such as a multiprocessor computing device.

The presently described method is able to distinguish between different literature genres, subject matter and between different authors writing styles. The information that is compared between texts is essentially relative word frequency, where each word can actually represent one or more space-delineated words and short-range syntax (adjacent words) from the original texts. Although, the present examples have used human language texts specifically in English, comparisons can be made with this method between texts of any language. Also the comparison method described is not limited to the comparison of books alone. In a generalized form the method can be applied to any string of information. For example the text strings may be biological sequence information such as DNA sequences, entire genome sequences, or amino acid sequences. The method can also be applied to other linear digitized information such as visual and audio information.

### BRIEF DESCRIPTION OF THE DRAWINGS

FIG. 1 is a flow chart for an exemplary embodiment of a system for comparing a database of linear information.

FIG. 2 is a flow chart for an exemplary embodiment of a system for preprocessing linear information.

FIG. 3A is a flow chart for an exemplary embodiment of data preprocessing which reduces data to a single string of information.

FIG. 3B shows a sample of how text is preprocessed.

FIG. 4 is a flow chart for an exemplary embodiment of a system for generating a Vocabulary Feature Profile (VFP).

FIG. 5 is a flow chart for an exemplary embodiment of a system for generating a Cumulative relative entropy profile (CREP).

FIG. 6 shows an example of vocabulary feature profiles (VFP).

FIG. 7 is an example of a Cumulative Relative Entropy Profile (CREP).

FIG. 8 is a flow chart for an exemplary embodiment of a system for creating a distance matrix from optimal L length FFPs.

FIG. 9 shows a tree generated from Keyword Only FFPs.

FIG. 10 shows a tree generated from concatenated feature FFPs. FIG. 11 shows a comparison of Primate whole genomes at the nucleic acid level using the FFP.

FIG. 12 shows the four hypotheses for placental (eutherian) mammalian divergence.

FIG. 13 is a graph showing the Genome sequence lengths of all the genomes compared.

FIG. 14 is a chart showing the number of words occurring more than once in a genome vs. l-mer word length.

FIG. 15 is a dendrogram of whole mammalian genomes.

FIG. 16 is an MDS plot of high coverage genomes by individual chromosome.

FIG. 17 is an MDS plot of chicken and platypus chromosomes.

FIG. 18 provides phylogenetic trees showing Genic, non-genic, and exonic human chromosomes contain similar relative distance information.

FIG. 19 shows the optimal feature (1-mer) length calculated. (a) Cumulative relative entropy (CRE) curves for 142 large dsDNA virus proteomes. (b) Relative sequence divergence (RSD) values for 4 representative viral proteomes, the smallest (NeleNPV), the intermediate (SHFV and CNPV), and the largest (APMV).

FIG. 20 shows graphs of feature-hits distribution and horizontal gene transfer (HGT).

FIG. 21 shows a visualization of a whole proteome tree.

The foregoing aspects and others will be readily appreciated by the skilled artisan from the following description of illustrative embodiments when read in conjunction with the accompanying drawings.

### DETAILED DESCRIPTION OF THE INVENTION

One embodiment of the invention is a computational method and system for the comparison and analysis of different objects of information within a database or collection. All objects are compared in a pair-wise fashion so the relative similarity between each object to every other object in the collection is known. The present invention also employs a vector based system and a distance measure to compare information. The present invention differs from the above in the manner in which the linear information is preprocessed and in the manner in which the optimal feature lengths are found. First human language texts are preprocessed by removing all punctuation marks and word delimiters (spaces). Entire texts are reduced to one long concatenated string. Next a short window of a given length is slid over the entire string and the frequencies of concatenated word fragments are counted. In the case of written texts these concatenated word fragments are able to capture the syntactical idiosyncrasies of specific authors as well as the unique vocabularies associated with a certain genre or subject matter.

In the present method, human language electronic texts are first pre-processed by transforming all letters to lowercase, removing spaces and punctuation, thereby removing the boundaries of words from the text. In one embodiment, each object in the database is preprocessed to remove word and punctuation boundaries. The data is preprocessed in such a way as to reduce the entire text to a long string of characters without the presence of any word or sentence delimiting boundaries. The frequencies of word fragments, or features, are used to reduce each item to a vector form which are herein referred as feature frequency profiles (FFP). The form of the information may not necessarily be human readable text but may also be in the form of un-annotated nucleic acid genomic sequence data or protein amino acid sequence. The information may also be in the form of machine readable code. The data must only be computer memory storable in a linear fashion. The nature of the content or information stored in irrelevant.

Then “words” (features represented by strings of alphabets) are counted with a sliding window of a given length of letters. In one embodiment the sliding window is eight letters as is used in the examples. Each text is then represented by a long vector of overlapping feature frequencies. Note, that the features are composed of portions of words and parts of preceding and following words. Thus, ‘short range’ syntax is encoded within the feature frequencies. The collection of frequencies for each l-letter length feature is used to form a word feature frequency profile.

A typical length text will be represented by a vector of several thousand features (“words”), where each feature occurs with a specific frequency. The vector is then length normalized, i.e. each frequency is divided by the total number of words found in the text. This enables texts of different length to be compared. Two texts, once converted to word vector form can be compared using many forms of distance or similarity measures. A collection of word vectors of several texts is stored in a word feature frequency profile. Several texts can be compared to each other in pairwise fashion, creating a distance or similarity matrix. The relative similarity of different texts to each other is visualized using multidimensional scaling, principal component analysis, hierarchical clustering or tree building. From the analysis, one can group similar books, index and catalogue them in a systematic hierarchy using a hierarchical clustering, neighbor joining, UPGMA or any other tree building method.

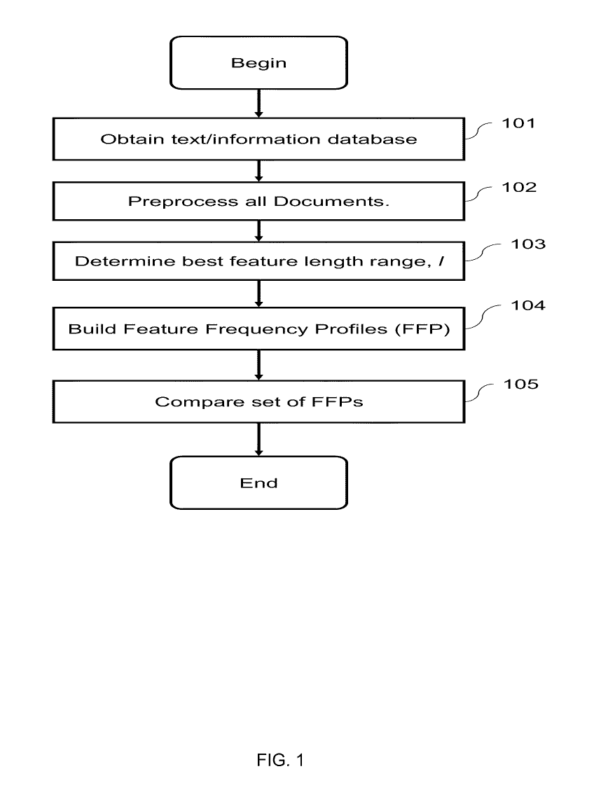

FIG. 1 shows the process for comparing a set of data. In this embodiment the data set compared 101 may include any kind of data which is storable in a digital, linear fashion. This kind of data may include, but is not limited to text documents, books, biological sequence data, web pages, images, audio, music and video.

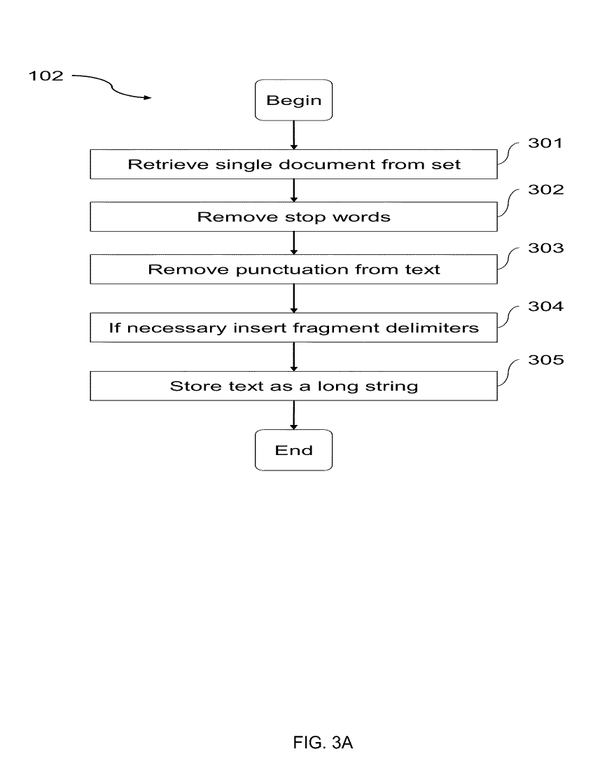

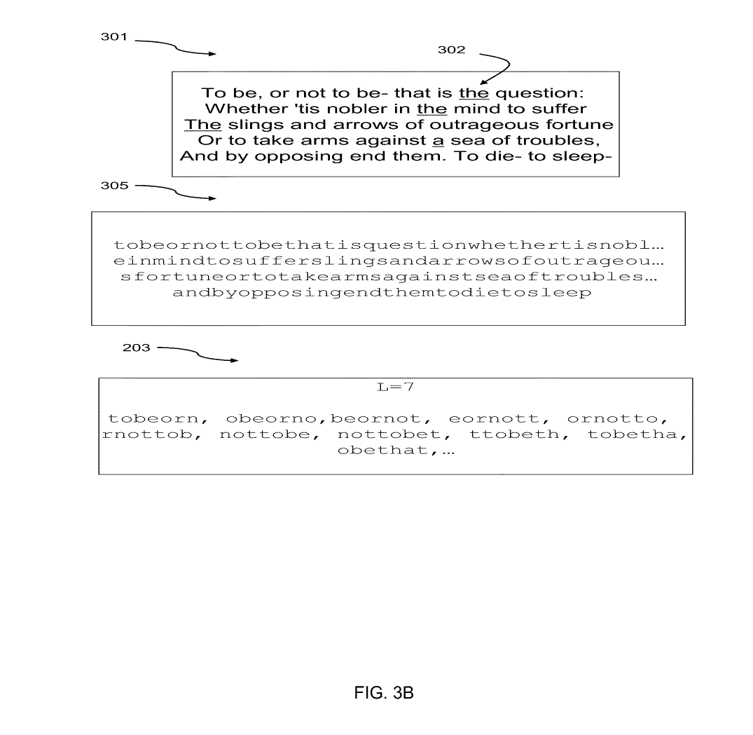

Each document within the dataset is preprocessed individually 102. For the case of text files a single document is obtained from the dataset 301. See the example of a fragment of text in FIG. 3B. A set of commonly occurring stop words are removed from the 302. These words, such as ‘a’, ‘an’ and ‘the’ occur so frequently in all texts they are of little use in determining similarity or in analyzing authorship. Next all punctuation (commas, apostrophes, quotes, colons, semicolons, periods, question marks, and exclamation points) and spaces are removed from the text 303. All capital letters are reduced to lower case. In certain embodiments it may be necessary to leave a delimiter or add a delimiting character between certain portions of text to force a division between portions that need to remain separate 304. The original text from 301 is now reduced to a long concatenated word string 305.

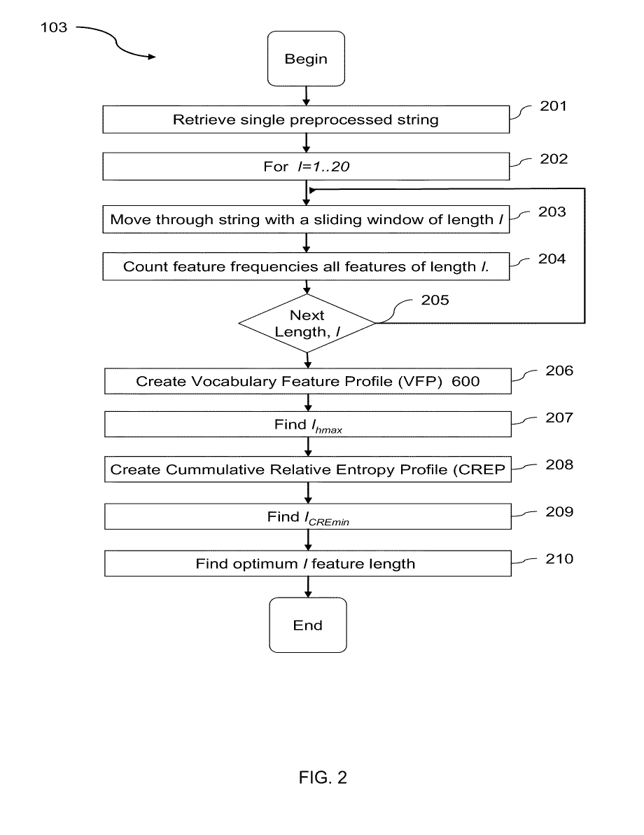

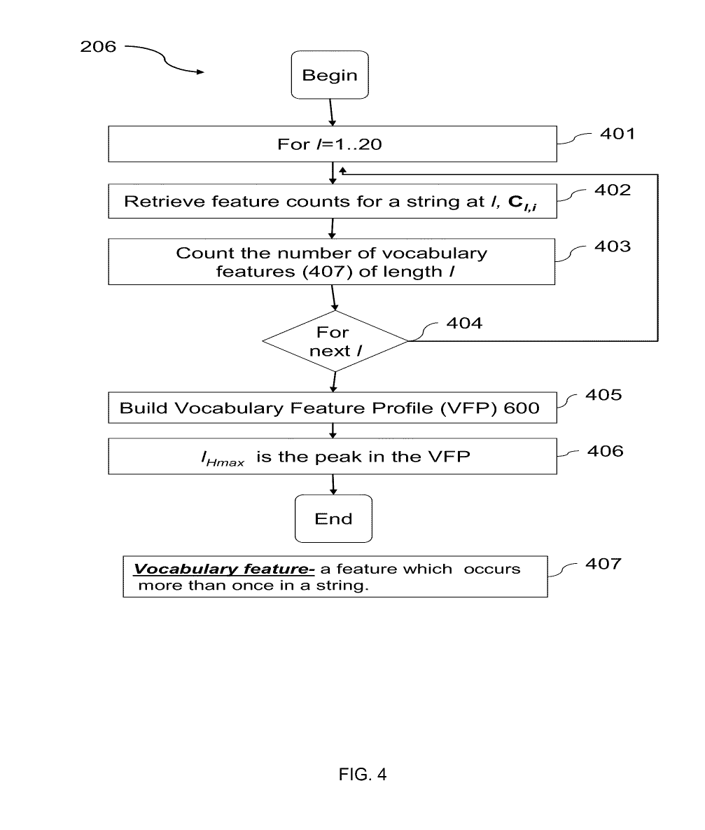

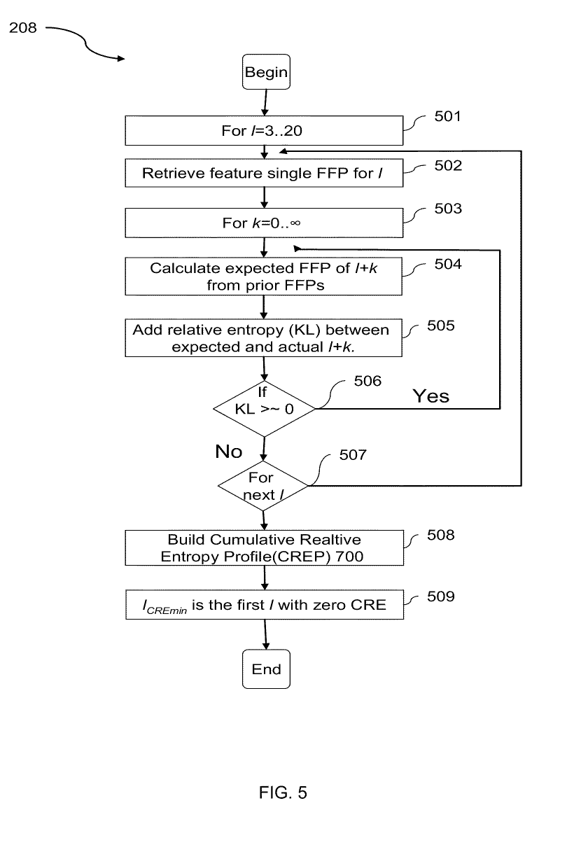

In state 103 the best length l for feature comparison must be determined from the processed text strings. FIG. 2 summarizes the process for selecting the best range of l for comparing processed text strings. In 201 a single processed string is obtained. For all lengths l from 1 to 20 (state 202), a window of length l is slid through the entire string and concatenated features (word fragments) of length l are extracted 203. The counts of each feature, the number of times it occurs in the string, are stored in vector form 204. The process is repeated for each length l 205. After all words have been counted for each length, then a vocabulary feature profile (VFP) is constructed 206. The details of constructing the VFP are discussed later (see FIG. 4), however the quantity l_{Hmax} 207 can be uniquely determined from the VFP. Next, a cumulative relative entropy profile (CREP) is constructed 208; the details of the construction thereof are also discussed below and in FIG. 5. The quantity lCREmin can be uniquely determined from the CREP 209. The optimum range of l 210 to use for comparing data will always lie between the uniquely determined quantities l_{Hmax} and l_{CREmin}. Therefore, this length range is used.

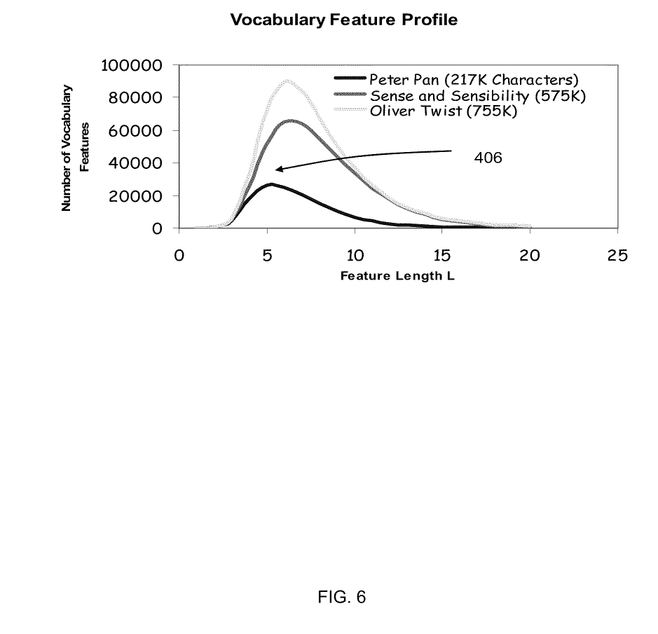

A VF profile can be created from the feature count information of a preprocessed string. FIG. 4 summarizes the process for constructing a VFP. For feature lengths l from 1 to 20 do the following 401. For all features of a given length l count the number of times that feature occurs in the preprocessed string, c_{l,i} 402. A vocabulary feature is defined as a feature occurring more than once in a string 407. The number of vocabulary features occurring at length l is totaled 403. The process is repeated for all l 404. The number of vocabulary features occurring at all lengths l is assembled into a profile 405. See FIG. 6 for an example of the vocabulary feature profile for several books. Notice that the shape of the VFP varies with several factors including the length of the book and the reading level of the book. Peter Pan is a juvenile book while the other two books are works of 19th century adult fiction. The peak of the VFP 406, l_{Hmax}, is a unique quantity for every text. Shorter books as well as books with a limited vocabulary, such as children's books, have smaller values of l_{Hmax}.

A CRE profile can be constructed from the feature frequency information of the preprocessed string. FIG. 5 shows a flow chart summarizing the creation of the CRE profile for a given string. The cumulative relative entropy (CRE) profile measures the ability of a particular length FFP, Fₗ and Fₗ₋₁, to predict the FFP distributions longer lengths than l. First the feature counts must be converted to a probability distribution of FFP, Fₗ,

$${F}_{l} = \frac{{C}_{l}}{{\sum }_{i} {c}_{l , i}} \qquad ( Equation 1 )$$

where: Cₗ is the vector of feature counts
c_{l,i} is the number of times feature i of length l occurs in the string.
   The FFP for all lengths l=1 to 20 are then found by applying the above conversion to all Cₗ for l=1 to 20.

The CREP profile is itself based upon the cumulative relative entropy. The relative entropy between two FFPs of length l, Pₗ and Qₗ is,

$$RE ( {P}_{l} , {Q}_{l} ) = {\sum }_{i = 1}^{K} {p}_{l , i} {log}_{2} \frac{{p}_{l , i}}{{q}_{l , i}} \qquad ( Equation 2 )$$

where: K is the number of features in Pₗ and Qₗ.
p_{l,j} and q_{l,i} are the frequencies of the ith features in Pₗ and Qₗ.
   The FFP for length, l, from the FFPs of l−1 and l-2 can be estimated by using an l-2 Markov chain model. The expected frequency, \hat{f}ₗ, of an l-mer given the prior knowledge of the FFP probability distribution of l−1 and l−2 is,

$${\hat{f}}_{{a}_{1} {a}_{2} ⋯ {a}_{l} {a}_{l}} = \frac{{f}_{{a}_{2} {a}_{3} ⋯ {a}_{l}} {f}_{{a}_{1} {a}_{2} ⋯ {a}_{l - 1}}}{{f}_{{a}_{2} {a}_{3} ⋯ {a}_{l - 1}}} \qquad ( Equation 3 )$$

where: fa₁a₂ . . . aₗ is the frequency of a feature from Fₗ₋₁ formed from the letters a₁a₂ . . . aₗ.
fa₂a₃ . . . aₗ is the frequency of a feature from Fₗ₋₁ formed from the letters a₂a₃ . . . aₗ.
fa₁a₃ . . . aₗ₋₁ is the frequency of a feature from Fₗ₋₁ formed from the letters a₁a₂ . . . aₗ₋₁.
fa₂a₃ . . . aₗ₋₁ is the frequency of a feature from Fₗ₋₂ formed from the letters a₂a₂ . . . aₗ₋₁.

An expected FFP, \hat{F}ₗ, can be found from Fₗ₋₁ and Fₗ₋₂. Further, \hat{F}ₗ and \hat{F}ₗ₋₁ can be used to find \hat{F}ₗ₊₁, and thus all \hat{F}ₗ₊ₖ up to infinite k can be found by iteratively applying the above relation to find the next longest expected FFP.

In order to measure how close the expected frequency is to the observed frequency for the entire probability distribution, the relative entropy (RE) between \hat{F}ₗ and Fₗ is computed. The cumulative relative entropy (CRE) at l is defined as the sum of relative entropy from l to infinity (but in practice one can stop when RE˜0):

$$CRE ( l ) = {\sum }_{i = l}^{∞} RE ( {\hat{F}}_{i} , {F}_{i} ) \qquad ( Equation 4 )$$

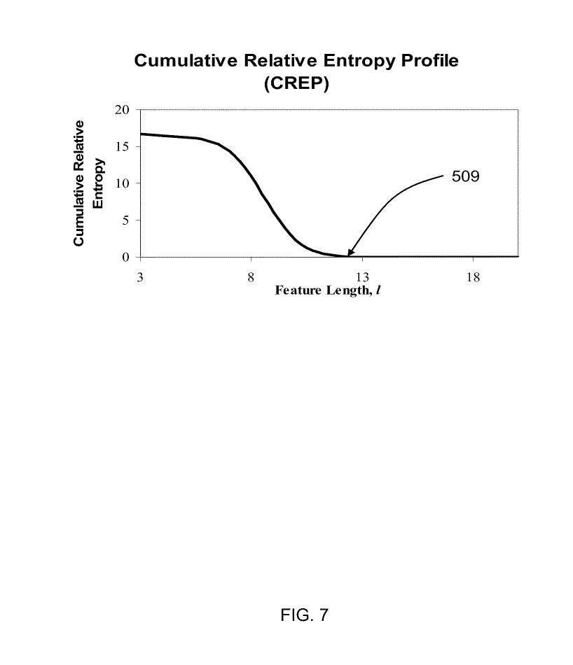

The CRE represents the accuracy of predicting FFPs for all lengths greater than or equal to l, given the prior distributions Fₗ₋₁ and Fₗ₋₂. For example starting at from l=3, F₂ and F₁ are used to calculate the expected FFP \hat{F}₃₋ₖ when k=0 at state 504. The RE entropy is calculated between F₃ and \hat{F}₃ . A cumulative total is kept of the relative entropies for all k 505. When the relative entropy equals zero, the running total is stopped 506 and then the CRE for the next l is calculated 507. If a given sequence has zero CRE at feature length l, then the FFPs Fₗ₋₁ and Fₗ₋₂ have all the information necessary to form longer features. CRE for all l is assembled into a CRE profile 508. See FIG. 7 for an example of a CRE profile. When CRE approaches zero, this value of l delineates the upper limit for comparison with this string 509. This zero point is designated as l_{CREmin}.

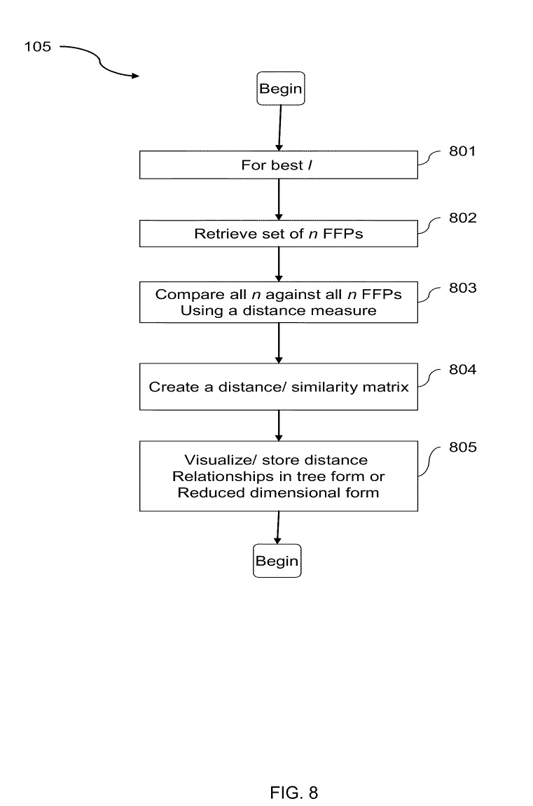

FIG. 8 shows a flow chart summarizing the process for comparing FFPs. First the best feature length (or feature length range) is chosen 801 as described above. The set of all FFPs is obtained 802, and then all FFPs are compared in an all against all (or pair-wise) fashion. The distance between two FFPs Pₗ and Qₗ is calculated using a distance metric. In one embodiment, the distance metric used is the Jensen-Shannon (JS) Divergence 803:

$$\begin{matrix}{JS}_{l} ( {P}_{l} , {Q}_{l} ) = \frac{1}{2} RE ( {P}_{l} , {M}_{l} ) + \frac{1}{2} RE ( {Q}_{l} , {M}_{l} ) & ( Equation 5 ) \\ where \text{:} {M}_{l} = \frac{1}{2} ( {P}_{l} + {Q}_{l} ) & ( Equation 6 )\end{matrix}$$

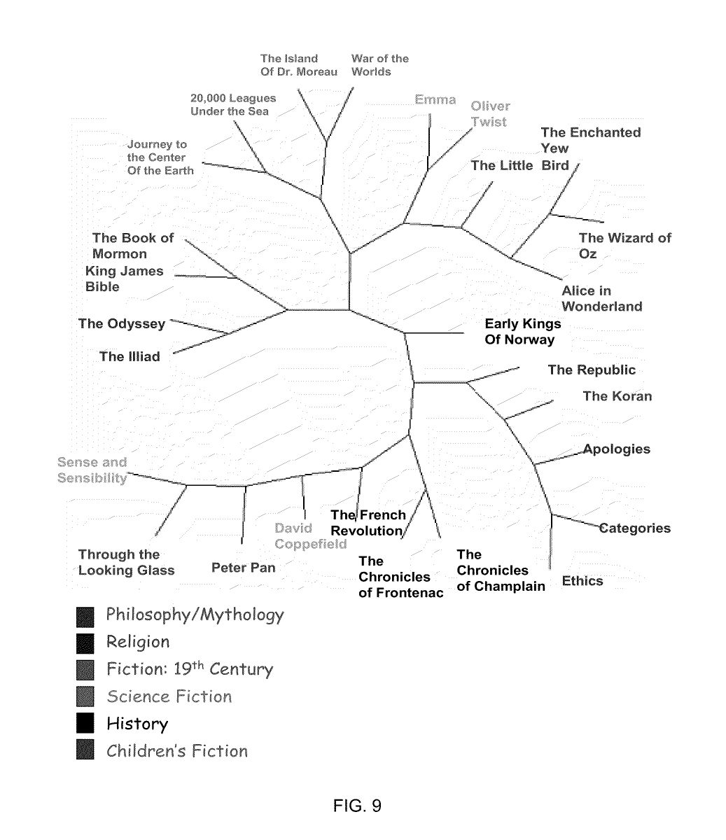

Mₗ is the average FFP of Pₗ and Qₗ.
RE is the relative entropy.
   The JS divergence is a convenient divergence measure for the purposes of the present invention because it is symmetric and bounded between 0 and 1. Note, that the JS divergence is not strictly a metric distance as it does not always satisfy triangle inequality. Many other forms of distance measure are suitable and those familiar with the art will recognize that the JS Divergence as used in this embodiment could be equally substituted with another distance metric. The pair-wise all-against-all distances are stored in the form of a distance matrix, D 804. In a distance matrix, identical objects have a distance of zero, and dissimilar objects have large distances. However for JS Divergences the maximum distance is 1. In other embodiments, a similarity metric could be used to compare FFPs, however through various transformations a similarity or distance matrix can be inter-converted. Finally the distance relationships between FFPs can be visualized 805 using a number of means. One way is to constructed a hierarchical binary tree using a tree reconstruction algorithm such as hierarchical clustering, UPGMA or Neighbor Joining. Several examples are presented here in tree form in FIGS. 9, 10, and 11. Other means of distance matrix visualization are dimensional reduction methods such as principal component analysis and multidimensional scaling.

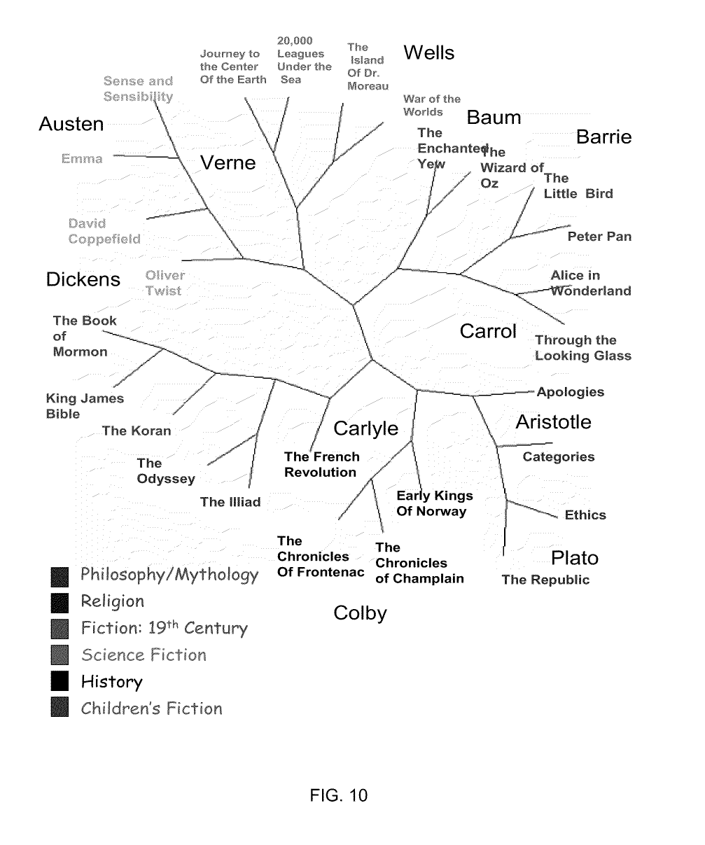

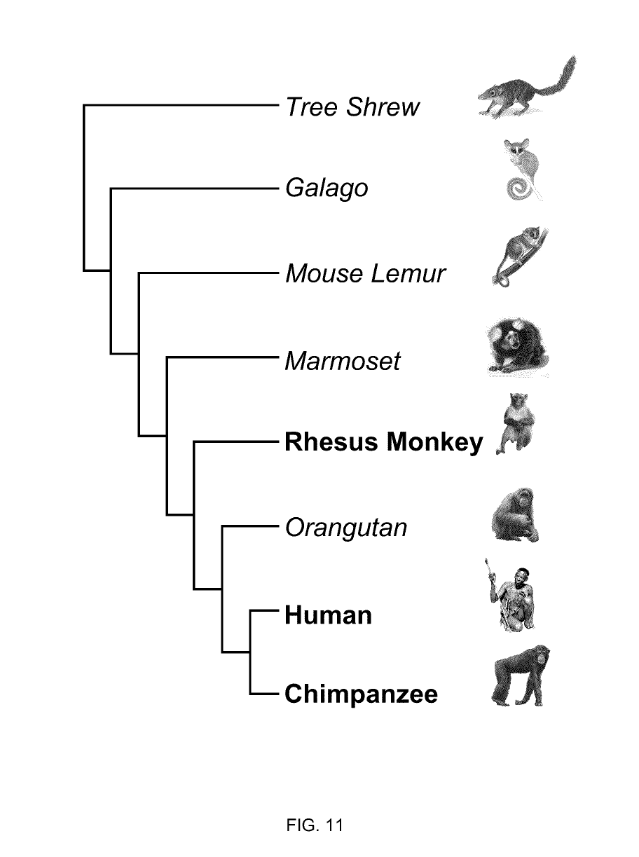

As shown in FIG. 9 and FIG. 10, two different kinds of features were used for FFP comparison to the presently described method. Nine genres of books were chosen and are indicated by different shading: philosophy, religion, 19th century social customs/fiction, science fiction, history and children's fiction. Among those genres, two books from each of 11 authors were selected: Plato, Aristotle, Homer, Charles William Colby, Thomas Carlyle, Lewis Carrol, J. M. Barrie, Frank L. Baum, H. G. Wells, Jules Verne, Jane Austen, and Charles Dickens. Some of the books, such as the “The Bible”, “The book of Mormon” and “The Koran” were not chosen in pairs by author.

Referring now to FIG. 9, a tree shows the relationships between texts using features composed of only space and punctuation delimited keywords as FFP features. Some of the different books are mixed into the wrong genre, and some of the books written by the same author do not cluster together. For example, “The Koran” is more closely related to Plato's “Republic” and “Apologies” than to the other religious texts. The 19th century adult fiction books are intermixed with juvenile fiction. “Alice in Wonderland” and “Through the Looking Glass” both by Lewis Carrol, and both about the central character “Alice” are quite distant from each other in the tree. FIG. 9 shows that texts written by the same author don't always cluster together and that books on dissimilar topics are mixed.

Referring now to FIG. 10, a tree is shown that is composed of l=8 length concatenated word features. All of the books cluster by both author and genre. Clearly the concatenated word features described in the present invention produce more sensible distance relationships. The method in this embodiment is especially sensitive to identifying similarities in authorship because of its ability to analyze short syntax and word order. FIG. 10 shows a text cluster by author and subject matter.

Thus, the present method is able to distinguish between different literature genres, subject matter and between different authors writing styles. The information that is compared between texts is essentially relative word frequency, where each word can actually represent one or more space-delineated words and short-range syntax (adjacent words) from the original texts. In some embodiments, the present system is demonstrated using pieces of English books to demonstrate the process, however it should be noted that present system and methods are not limited to works of literature but could be applied to any form of written material, including but not limited to, computer programming code, or even biological sequence data, such as nucleic acid or genomic sequence data.

Genomic sequences can be analyzed in exactly the same way as human language texts, using the FFP method. FIG. 11 shows a neighbor joining tree of the similarities between primate genomes as analyzed using the present method. All of the genomes used are publicly available and can be found at the National Center for Biotechnology Information (NCBI). Preprocessing for the removal of spaces and punctuation is unnecessary in this case as genomes are already stored in the form of a long string. However, special adaptations of the FFP method must be made for large genome comparison. The use of all possible l-mer features for especially long genomes, or especially long 1 has computer memory allocation limitations, so feature filtering may be necessary. One effective form of l-mer filtering is to assume that some words are degenerate because sequence evolution is indeed tolerant of many kinds of sequence substitutions. For example, in nucleotide sequences, the bases A and G (both purine bases), and C and T (both pyrimidines) can form two equivalent classes R and Y. Thus the 4 base alphabet sequence:
AGTCATATACCA

would be translated to the 2 letter R-Y alphabet:
RRYYRYRYRYYR.

The reduced alphabet is especially useful for comparing large genomes, because it substantially reduces memory allocation requirements. A further reduction can be accomplished by establishing equivalency between the reverse complement and its forward sequence. Both the R-Y alphabet and reverse complement matching were employed in comparisons of primate genomes, and features of length l=24 were used. For large genomes, such as this example, a multi-processor machine is used to calculate and compare FFPs.

The genomes of higher order Eukaryotes contain a large fraction of sequence which is repetitive or of low complexity, most often in non-genic or inter-genic regions. For genomes where the coverage is low or the assembly is incomplete, better results are observed if these sequences are removed. The complexity of a feature, K_{f}, is determined by comparing its size in bytes, before and after lossless compression.

K_{f}=|s−s_{compress}−s_{header}| Equation 7
where the compression is implemented with a compression utility, e.g., gzip.
s is the original size of the feature,
s_{compress} is the compressed size of the feature,
and s_{header} is a fixed length header associated with the compression
algorithm, for gzip s_{header}=28.

The complexity of l-mers for a given l is normally distributed, and one can choose only the most complex features, which are generally of low frequency. Features with complexity greater than the average complexity μ(μ=10 for l=24), where μ is the average complexity are used for comparison.

In one embodiment, high frequency features should be disregarded because these frequency values tend to dominate the Jensen-Shannon distance score. The average (μ) and standard deviation (σ) of the count values, c_{l,i} for all genomes are calculated and only those features in the range of 1≦c_{l,i}≦μ+σ a are used for comparison.

All of the features described above may be embodied in software code and executed by a personal or general use computer. In one embodiment, a system comprising a computer having a processor and storage and a computer-implemented process of alignment-free comparison as described herein.

In another embodiment, the system may incorporate a multi-processor computer array to facilitate faster comparison of large databases or especially large data files. And in another embodiment, the system includes a web server that generates and serves pages of a host web site to computing devices of end users. The computing devices may include a variety of other types of devices, such as cellular telephones and Personal Digital Assistants (PDA). Tb web server may he implemented as a single physical server or a collection of physical servers. Certain embodiments may alternatively be embodied in another type of multi-user, interactive system, such as an interactive television system, or an online services network.

In such an embodiment, the web server provides user access to electronic information represented within a database or a collection of databases. An information acquisition processor that runs on, or in association with, the web server provides functionality for users to enter a search query for information they would like to find. In one embodiment, the information represented in the database may include documents, characters, words, images, songs, or videos or any other data that may be stored electronically and analyzed in linear form by the present methods. Many hundreds of thousands or millions of bytes of data may be stored in the database.

For example, in one embodiment, a document or other object in the information database may be retrieved using the information acquisition processor. Each object may be located by, for example, conducting a search for the item via the information acquisition processor, or by selecting the object from a browse tree listing.

In response to a query received by the information acquisition processor, the system sends the query to an FFP generator, which in addition to receiving the query, obtains the data to be queried and compared and generates the feature frequency profiles and the other vector profiles such as the vocabulary feature profile, and the cumulative relative entropy profile. The data can be stored in a database in order to generate the profile information based on the query along with the subsequent vectors and profiles generated. In certain system embodiments, a set limit can be placed on the number of FFPs that are created in order to address the substantially large amounts of relationships that can be created in web space, as discussed above.

The resulting profiles are then sent to the query results processor, which processes the results using the comparison process of the present invention, and optionally creates a visual representation of the distances and relationships found, and sends this data to the information acquisition processor. In one embodiment, the query results processor is a parallel processor or clustered machine which may be required if the data to be queried is very large, e.g., entire genomes or proteomes of several organisms. The results data may then be returned to computing devices that submitted the query via the Internet.

In another embodiment, the system comprising modules to carry out various steps as outlined in the FIG.s. For example, a module to find the optimum feature length having instructions to (a) retrieve a single preprocessed string 201, (b) for l=1 to 20, 202, move through each string with a sliding window of length l 203, (c) count feature frequencies of all features of length l, 204, (d) repeat for next length l 205, (e) create Vocabulary Feature Profile 206, (f) find lₘₐₓ 207, (g) create cumulative relative entropy profile (CREP) 208, (h) find l_{CREmin} 209, and (i) find optimum l feature length 210.

All of the various embodiments and methods described herein fall within the scope of this invention. As shown by the three examples, book comparison, primate genome comparison, other embodiments that are apparent to those of skill in the art, including embodiments which do not provide all of the benefits and features set forth herein and do not address all of the problems set forth herein, are also within the scope of this invention.

### EXAMPLE 1

### Whole Genome Comparison of Placental Mammals, Using Feature Frequency Profiles (FFP), an Alignment-Free Method

The present whole genome comparison of placental mammals, using feature frequency profiles (FFP), an alignment-free method is further described herein below.

The comparison of two closely related genomes at the base-by-base nucleotide sequence level can be routinely accomplished by traditional sequence alignment. However, as species diverge over time, genomic rearrangements, such as gene transposition, deletion and duplication make sequence alignment impractical. An alignment free method, such as the scheme presented here, can be used to overcome these issues associated with genome comparison. The FFP alignment-free method can compare genomes in their entirety at the nucleotide level in both the genic and non-genic regions. This method divides sequences into overlapping ‘words’ or l-mers of a given length or resolution, l. Then, two genomes are compared based on the relative differences in feature frequencies.

The present invention can be applied to the study of higher-order Eukaryotic phylogeny, especially of the placental mammals (Eutherians). The determination of the root of the placental lineage is a current subject of debate. The NIH funded-Mammalian Genome Project, led by a collaboration of the Broad Institute, Baylor and Washington Universities has sequenced many mammalian genomes to at least 1-2× coverage (each base is represented at least 1-2 times in overlapping sequence fragments). These low coverage genomes are a collection of unassembled contig/supercontig sequences. The whole-sequence alignment-free method is an ideal approach for comparing these fragmentary low-coverage genomes.

Based on previous molecular sequence analysis, the Eutherian mammals can be divided into four primary groups Afrotheria (elephants, manatees, aardvarks, tenrecs), Xenarthra (armadillos, sloths and anteaters), Laurasiatheria (cows, cats, dogs, bats, cetaceans), and Euarchontoglires (archonta-primates+glires-rabbits and rodents). Four contradictory hypotheses have been proposed for Eutherian diversification: Exafroplacentalia (afrotheria diverged first) (Murphy W J, et al. (2001) Science. 294, 2348-2351), Atlantogenata (Xenarthra and Afrotheria are sisters, but their common ancestor diverged first) (Douady C J, et al., (2002) Mol Phylogenet. Evol. 25, 200-209), Epitheria (Xenarthra diverged first) (Kriegs J O, et al., (2006) PLoS Biol 4, e91) and Exrodentiaplacentalia. (rodents diverged first, and rabbits diverged next). (Misawa K, Nei M (2003) J Mol Evol 57,S290-S296).

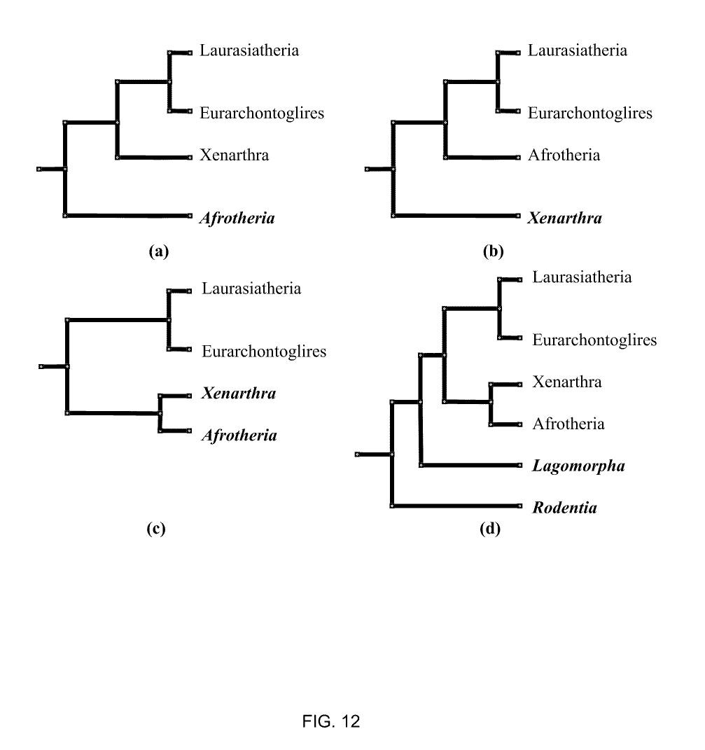

FIG. 12 shows the tree topology indicated by each of the four scenarios. The Atlantogenata hypothesis has an appealing biogeographical explanation. Accordingly, Xenarthra and Afrotheria have a common origin in the Godwanan southern continent. Their subsequent divergence was by the formation of the Atlantic Ocean through tectonic action. FIG. 12(a) shows Exafroplacentalia, where Afrotheria diverges first. FIG. 12(b) shows Epitheria, where Xenarthra diverges first. FIG. 12(c) shows Atlantogenata, where a common ancestor of Xenarthra and Afrotheria diverges first. FIG. 12(d) shows exrodentiaplacentalia, where Glires (rodents and rabbits) is split into a polyphyletic group, where Rodentia diverges first.

Results, Genome Size

Block-FFP, and Optimal Resolution

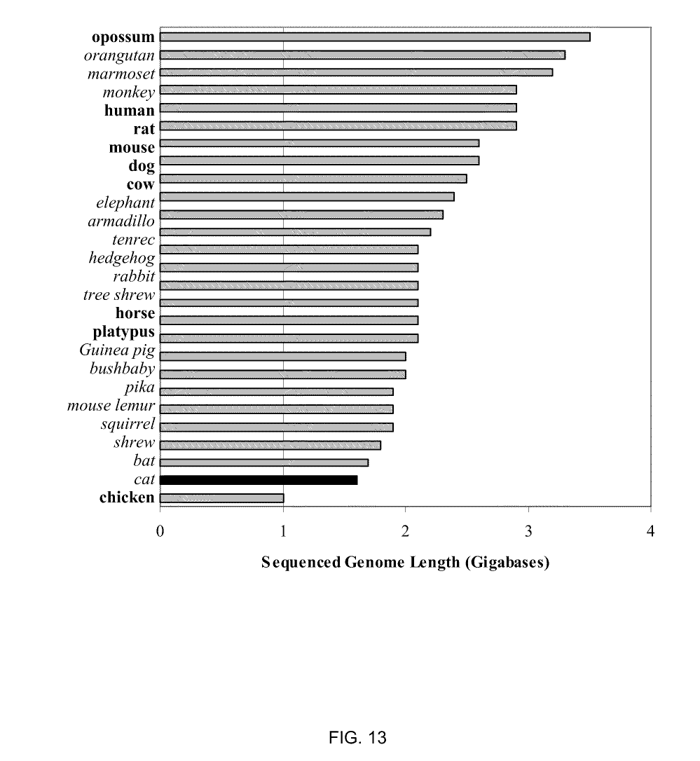

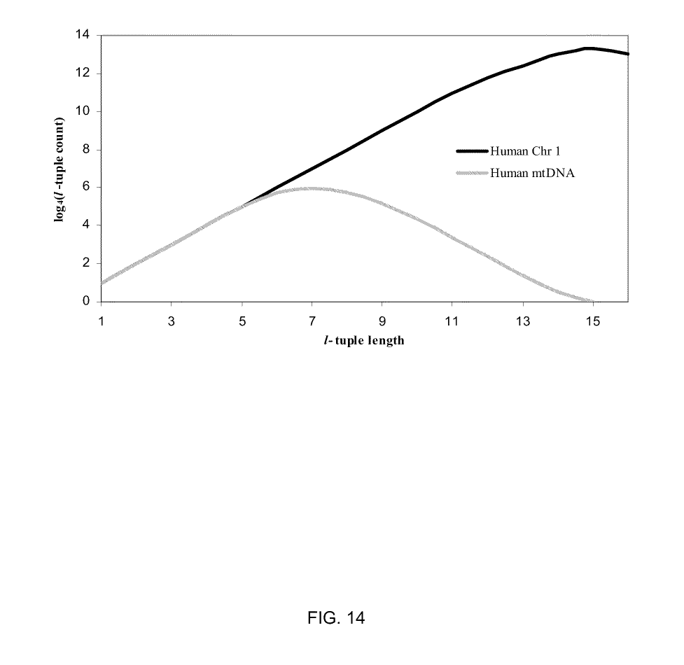

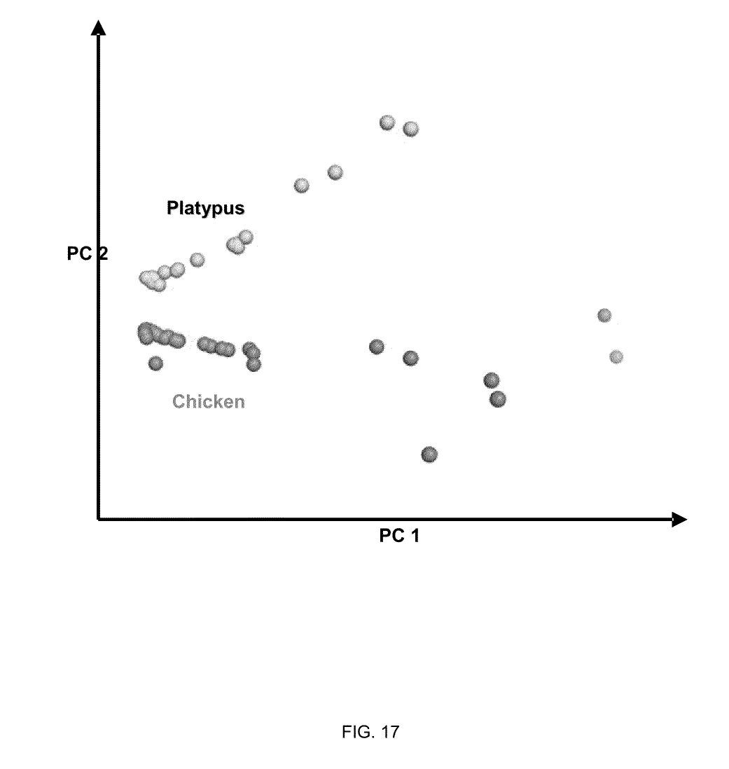

A few preliminary steps are necessary before a set of genomes can be compared. The initial step is to check the sizes of all the genomes, within the comparison set. The range in size from smallest to largest genome should be less than 4 fold and this is the case with our genome set, as shown in FIG. 13. FIG. 13 shows that the ratio of the smallest to largest genome is less than 4 fold, therefore showing that length standardization is unnecessary. FIG. 13 also shows that only 65% of the euchromatin was sequenced for the cat genome (black). However for the comparison of individual chromosomes, as shown in FIG. 17, the range in size is much larger; therefore, in this case the block-FFP method comparison is used. The block size is equal to the length of the smallest chromosome in the dataset (the human Y chromosome). The second step is to determine the optimal range of lengths, l, from which the FFP is constructed. This is determined using a feature vocabulary profile, as shown in FIG. 14, and a cumulative information capacity profile (see methods), both of which are functions of genome length and feature usage. FIG. 14 shows that both genomes have a peaked distribution, and the location of the peak dictated by the genome length. FIG. 14(a) shows human chromosome 22. The peak for this small human chromosome occurs at length lHmax=13. FIG. 14(b) shows the human mitochondrial genome. The mitochondrial DNA sequence is relatively small (16 kbases), l_{Hmax}=7. It was determined that the best l value to use for whole genome comparison of the mammalian set is l=24, The best l for comparing whole chromosomes with a block size m=25 Mbases (the length of the Y chromosome), is l=15.

Whole Genome Comparison

In this study, two methods were used for displaying the relatedness among genomes: multi-dimensional scaling (MDS) and tree building. Tree topologies were constructed from distance matrices from the FFP method. Features of length l=24 were used to form FFPs and calculated a Jensen Shannon divergence matrix. The matrix Dₗ₌₂₄, was used to construct a tree with the neighbor joining (FIG. 4) method. Cross validation was used to access the tree robustness. The tree topology supports the Atlantogenata hypothesis. The root of the tree is in agreement with the atlantogenata hypothesis and with Xenarthra diverging first from their Gondwonan ancestor. Note that Eulipotyphla is placed within glires, rather than Laurasiatheria, however with low support (41).

Individual Chromosome Comparison

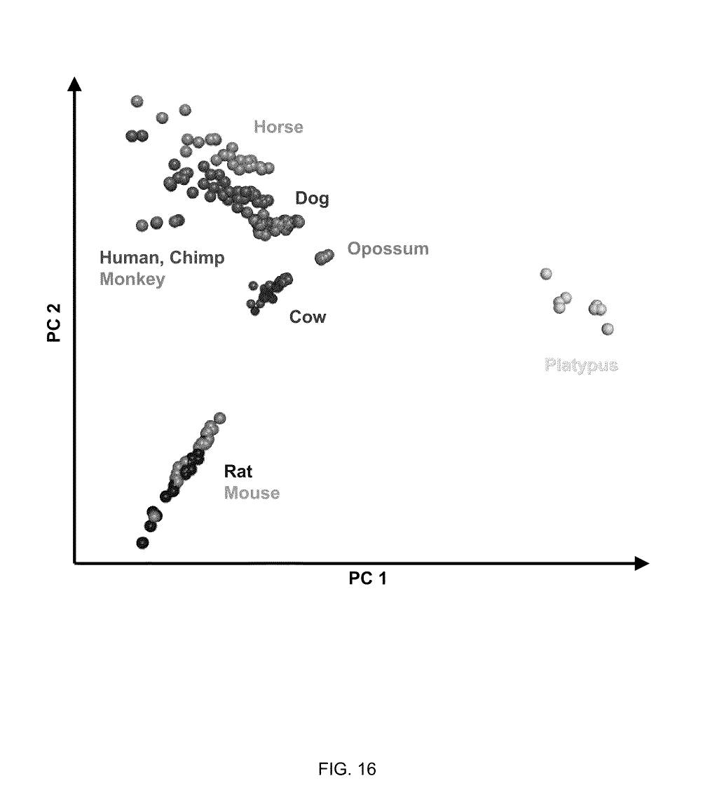

The present invention can also compare genomes on the individual chromosome level. Only the higher coverage genomes are assembled into chromosomes. The MDS method can display distance information in the form of a two or three dimensional map. MDS can be used for both dimensional reduction and clustering. MDS are used primarily for clustering, which allows us to visually examine the distance relationships between the mammalian genomes. This technique also allows for the examination of clustering without implying any phylogenetic relationship. FIG. 16 is a plot of the first two dimensions resulting from the MDS decomposition of the Dₗ₌₁₇ matrix. FIG. 16 shows chromosomes from cluster by species. The therian (marsupia+eutheria) chromosomes cluster fairly tightly into ovoid-shaped clusters. Rat and Mouse, as well as Chimp, Human and Macaque appear as mixed clusters. In the MDS space, a point represents each chromosome and related chromosomes are spatially close. The main cluster of chromosomes consists of the Eutherian mammals, and the outliers are platypus, opossum, and chicken (not shown). The Eutherian chromosomes cluster fairly tightly into spherical-shaped clusters, while chicken, platypus and opossum spread out into long bands. Some Platypus chromosomes are more closely associated with the opossum, while others, particularly the smaller chromosomes and sex chromosomes (11, 14, 15, 17, 20, X2, X3) are more closely associated with chicken chromosomes, as shown in FIG. 17. FIG. 17 shows that Platypus and Chicken have similar chromosome size distributions in their karyotype. Both sets of chromosomes do not form a tight cluster as do the therian mammals. All of the primate chromosomes form one cluster. Each human chromosome is closely associated with a chimp chromosome, with both being more distantly related to the monkey chromosome. There are several exceptions to this general topological arrangement. Chimp chr 2B, is more closely related to monkey chr 12, that to the entire human chr 2. This is because Human chr 2 is a fusion of chimp chromosomes 2A and 2B. Also, Rhesus monkey does not possess chromosomes perfectly homologous to human/chimp chr 14, 21, or 22. Using our method it might be inferred that chr 21 was derived from the monkey chr 3, and likewise chr 22 from monkey chr 10, and chr 14 from monkey 7. All other chromosomes remain unmixed between species. The murids, mouse and rat, appear as two distinct, yet closely related clusters.

Genic and Non-Genic Chromosome Comparisons

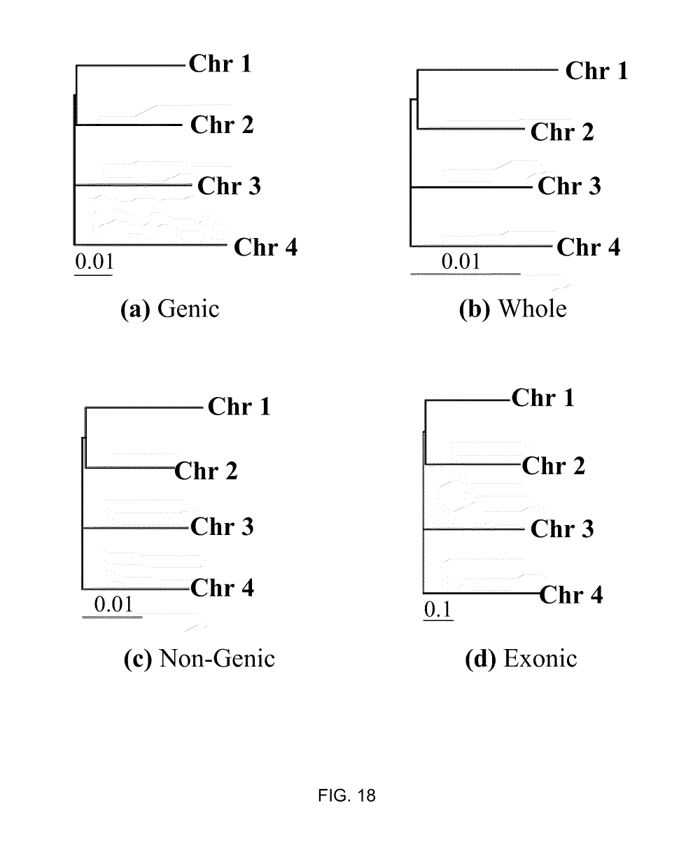

The majority of Eukaryotic genomes are composed of non-coding sequence. The present invention allows for the determining whether the non-coding sequence contains evolutionary information, and to what extent similar information is shared between the non-coding and genic sequence. Presumably, comparison of one genome to another using our method would primarily be a comparison of the non-coding sequence, as this is the major element. The present invention allows for determining whether comparisons of genic portions yielded similar genomic distance relationships as non-genic portions. Results of this test were shown in FIG. 18. FIG. 18 shows a topological comparison of the distance relationships between (a) whole chromosome (genic+nongenic), (b) genic (c) non-genic and (d) exonic human chromosomes. Dₗ₋₂₄ is used. Figure branch lengths are in units of Jensen-Shannon Divergence, which range from 0 to 1. A set of 4 human chromosomes each was partitioned into a genic chromosome, a non-genic chromosome and an exon chromosome. All partitions have the same topological relationship to each other as the complete un-partitioned chromosomes.

Discussion and Conclusion

The Eutherian phylogeny observed by using the FFP alignment free method most and atlantogenata divergence hypothesis. FIG. 16, clearly indicates an early divergence of Xenarthra and a sister relationship with Afrotheria., which can be explained primarily by vicariance effect (speciation by geographic separation). A peculiar case within the tree is the inclusion of Eulipotyphla (shrews and moles) in the glires clade, however with low support. This placement has been observed by Douady et al. (2004) Mol Phylogenet. Evol. 30, 778-788, after a re-analysis of previous studies, however many studies tend to place Eulipotyphla at a basal or near basal position among Laurasiatherians. The placement of the tree shrew within the phylogeny, because it has been thought of as a ‘primitive primate’, is a matter of contentious debate. The tree shrew is positioned basally in glires in our tree, however some studies have placed it at the base of the Euarchonta clade Also, our tree does not support the ‘pegasoferae’ Glade, where chiroptera (bats) is nested closely within Laurasiatheria as a sister to perrisodactyla (e.g. horses). Instead Chiroptera is at the base of the Laurasiatherian clade.

The present invention allows for examining the sequence similarity between chromosomes of several species (i.e. an all chromosome to all chromosome comparison.) Presumably this would recover some information about how specific chromosomes evolve. This was possible for the higher coverage depth genomes, where individual chromosomes have been assembled, not however for the survey genomes. A particularly surprising result was the quality of the clustering observed between chromosomes of a particular species (FIG. 5), specifically the therians (marsupials and placental mammals). Unfortunately this result is not very informative in tracing chromosome evolution. According to our method, most Eutherian chromosomes are only closely related to another chromosome within the same species. The exceptions are the primates, (Chimp, Human and Rhesus Monkey) which are thoroughly mixed together within a single cluster. This may reflect the pervasiveness of transposable elements (eg. LINES and SINES) throughout the entire genome. This would imply that there is a high frequency of inter-chromosomal mixing within therians. As therians evolved there may have been a tendency for this mixing/transposition to accelerate.

Contrast this to the inter-chromosomal similarity of platypus and chicken, both are spread into long bands (FIG. 17). Many of the Platypus chromosomes are in the neighborhood of some of the chicken chromosomes, which may be related to the fact that the platypus is a monotreme, a group of egg laying mammals. Also the platypus has a dispersed sex chromosome structure, where as many as 10 chromosomes function in sex determination, including bird like W and Z chromosome structures. The relatedness of several chromosomes is likely a result of the shared reptilian-like features between the two species. The karyotype of the platypus is also similar to birds/reptiles. Specifically, there is a large range in chromosome size, from very large to very small, which is unusual among therians and characteristic of monotremes, like the Platypus and the Echidna. However, the overall similarity of the two genomes is much less, than the similarity of some of the individual chromosomes.

It was observed in the test case that the comparison of genic or non-genic sequences give similar distance information, as shown in FIG. 18. A set of four chromosomes were compared where the nucleotide sequence was partitioned four different ways: genic+non-genic, non-genic only, genic only and exonic only. The results are particularly interesting, because non-genic DNA is considered to be under less directed evolutionary pressure. However, all three kinds of chromosomal DNA appear to possess, as least across a recent time-scale, similar records of divergence. It should be noted that the non-genic portions had been filtered out by removing highly repetitive low complexity features of the DNA as part of a pre-processing step (see methods). Regardless, it is believed that the analysis of the non-genic portions of genomes may contain as much evolutionary information as the more commonly studied nuclear coding sequences.

Thus, the alignment free FFP method according to an exemplary embodiment of the present invention is a useful tool for comparing genomes because it provides an unbiased measure of similarity, and is especially useful in the absence of a multiple sequence alignment. A key advantage of this method its ability to compare genic and non-genic sequence with equal utility. Whole genome sequence comparison provides much promise.

Materials and Methods

Data

Twenty-seven genomes were obtained from the public sources below. The following genomes where obtained from NCBI (ftp.ncbi.nlm.nih.gov): Homo sapiens, Mus, musculus (Mouse), Rattus norvegicus (Rat), Gallus gallus (Chicken), Pan troglodytes (Chimp), Ornithorhynchus anatinus (Platypus), Macaca mulatta (Monkey), Monodelphis domestica (Opposum), Equus caballus (Horse), Canis familiaris (Dog), Bos taurus (Cow). The next set of genomes was obtained from the Broad Institute (ftp.broad.mit.edu): Felis catus (Cat), Erinaceus europeaus (Hedgehog), Echinops telfari (Tenrec), Dasypus novemicinctus (Armadillo), Cavia porcellus (Guinea pig), Loxodonta Africana (Elephant), Microcebus murinus (mouse lemur), Myotis lucifugus (Microbat), Ochotona princeps (Pika), Oryctolagus cuniculus (Rabbit), Otolemur garnetti (Bushbaby), Sorex araneus (common shrew), Spermophilis tridecemlineatus (squirrel), Tupaia belangeri (tree shrew). Washington University (genome.wustl.edu): Pongo pygmaeus (orangutan), Callithrix jacchus (marmoset, new world monkey). Genomes from the latter two sources are low coverage sequences (1-2x) and consist of many unassembled contigs.

Methods

Feature Frequency Profiles and JS Divergence

To count the frequencies of each word in the genome, a sliding window of length l is run through the nucleic acid sequence from base position 1 to n−l+1. Several of the genomes are represented by a collection of assembled chromosomes and others are just a collection of unassembled contigs. When counting, l-mers continue over the whole genome, but the sliding window does not span over gaps present from sequencing. The counts are tabulated in the vector Cₗ,

Cₗ=<cₙ, . . . , c_{lK} (1)

where K is the number of features. The raw frequency counts are normalized to form a probability distribution vector or frequency profile,

$${F}_{l} = \frac{{C}_{l}}{\vert {C}_{l} \vert} \qquad ( 2 )$$

giving the relative abundance of each l-mers. This normalization removes the sequence length dependence.

The distance between two probability vectors Pₗ and Qₗ is calculated using the Jensen-Shannon (JS) divergence,

$$\begin{matrix}{JS}_{l} ( {P}_{l} , {Q}_{l} ) = \frac{1}{2} KL ( {P}_{l} , {M}_{l} ) + \frac{1}{2} KL ( {Q}_{l} , {M}_{l} ) & ( 3 ) \\ {M}_{l} = \frac{1}{2} ( {P}_{l} + {Q}_{l} ) & ( 4 )\end{matrix}$$

where KL is the Kullback-Leibler divergence,

$$KL ( P , Q ) = {\sum }_{i = 1}^{K} {p}_{i} {log}_{2} \frac{{p}_{i}}{{q}_{i}} \qquad ( 5 )$$

The JS divergence is a convenient distance measure for our purpose because it is metric and bounded between zero and one. In practice the JS divergence information is in the form of a distance matrix, D, containing pair-wise distances between genomes. For a set of n genomes, an n by n divergence matrix, Dₗ is formed by computing pairwise JS divergences using a specific feature length l.

Filtered l-mer Sets and the Purine-Pyrimidine Alphabet

The use of all l-mers for especially long sequences has some memory allocation limitations. The Cₗ count vector is implemented as a hash table data structure. Two forms of filtering were employed to overcome this limitation: 1) a reduced alphabet and 2) reverse/forward complement matching.

1) The most effective form of l-mer reduction is to assume that some words may be equivalent to each other, and indeed this is a logical manner in which to proceed, because sequence evolution is tolerant of many kinds of sequence substitutions. The bases A and G (both purine bases), and C and T (pyrimidines) can form two equivalent bases U and Y. Thus the 4 base alphabet sequence:

AGTCATATACCA

In the 2 letter alphabet, would be translated to:

UUYYUYUYUYYU

The reduced alphabet is especially usefully for comparing large genomes, because it substantially reduces the number of 1-mers which must be stored in the Cₗ frequency hash table.

2) Another step was taken to reduce the l-mer set size by allowing the reverse complement to match the forward sequence. The above forward sequence would be equivalent to its reverse complement:

YUUYUYUYUUYY

Only the forward or reverse complement need be stored and counted, thus reducing the hash table size by roughly half. For an even length l, the number of features:

$$K = {2}^{l} ( 5 + 1 )$$

$$and for odd length l \text{:}$$

$$\frac{{2}^{l} + {2}^{l / 2}}{2} ( 5 + 2 )$$

Removal of Highly Repetitive and Low Complexity Words

The genomes of higher order Eukaryotes contain a large fraction of sequence which is repetitive or of low complexity, most often in non-coding or inter-genic regions of the chromosomes. For genomes where the coverage is low or the assembly is incomplete, it has been observed better results if these sequences are removed. Naturally, these regions are typically the most difficult to assemble in any sequencing project, and as a result are the least complete. The complexity of a feature, K_{c} is determined by comparing the size in bytes of the feature, before, s, and after lossless compression, s_{compress}.

K_{c}=|s−s_{compress} (6)

The compression is implemented simply using the gzip utility (with the—best argument). The complexity of features for a given l is normally distributed, and one can then choose only the most complex words. In the primate whole genome example, words of high complexity lying outside of μ+σ (μ=10,σ=3) were used.

Also, high frequency words are removed from the set of l-mers because these frequency values tend to dominate the Jensen-Shannon divergence score. The average and deviation of the count values in Cₗ for all genomes was calculated in the primate examples and only those features which occurred less than μ+σ times were chosen. In this case, the distribution of word frequencies is extremely skewed to high frequencies, with the majority of 2-letter words occurring between 100-300 times.

$$\frac{{n}_{j}}{{n}_{i}} \geq 4 \qquad ( 7 )$$

where nⱼ is the length of the larger of the two genomes, i and 4 is the base alphabet size. Note, for comparison of large chromosomes, a simplified 2-letter alphabet was used for computational expediency. When sequences a and b are compared, each sequence is divided into m length blocks.

$$\{ \begin{matrix}\frac{1}{A} {\sum }_{i}^{A} min [ {D}_{l} ( {a}_{i} , {b}_{1} ) , ⋯ , {D}_{l} ( {a}_{i} , {b}_{B} ) ] + \\ \frac{1}{B} {\sum }_{j}^{B} min [ {D}_{l} ( {b}_{j} , {a}_{i} ) , ⋯ , {D}_{l} ( {b}_{j} , {a}_{A} ) ]\end{matrix} \} / 2 \qquad ( 8 )$$

In this case Dₗ is the distance between each block-to-block comparison, and the probability distribution, Fₗ, is for each m-length block.

Genic, Non-Genic and Exonic Chromosomes

To compare tree topologies between non-genic, genic, and exonic genome sequences, the present invention partitioned human chromosomes 1 through 4 using the following method. First, the Genebank record (.gbk) for each chromosome was obtained. Those regions of the chromosome annotated as genes were concatenated together, with a special (‘X’) character separating the two sequences. This special character serves as stop marker to prevent l-mers overlapping gene segments. Note a large number of these genes are predicted. These genes form the genic chromosome. All regions in the chromosome assembly, not highlighted as genes in the .gbk record are concatenated together forming the non-genic chromosome. Finally all exons from the .gbk record are placed together forming the exonic chromosome. The various partitioned chromosomes were compared and their topological relationships are shown with a neighbor joining tree, as shown in FIG. 7. Dₗ₌₁₇ distance information is used.

Jackknife Validation Tests with FFP

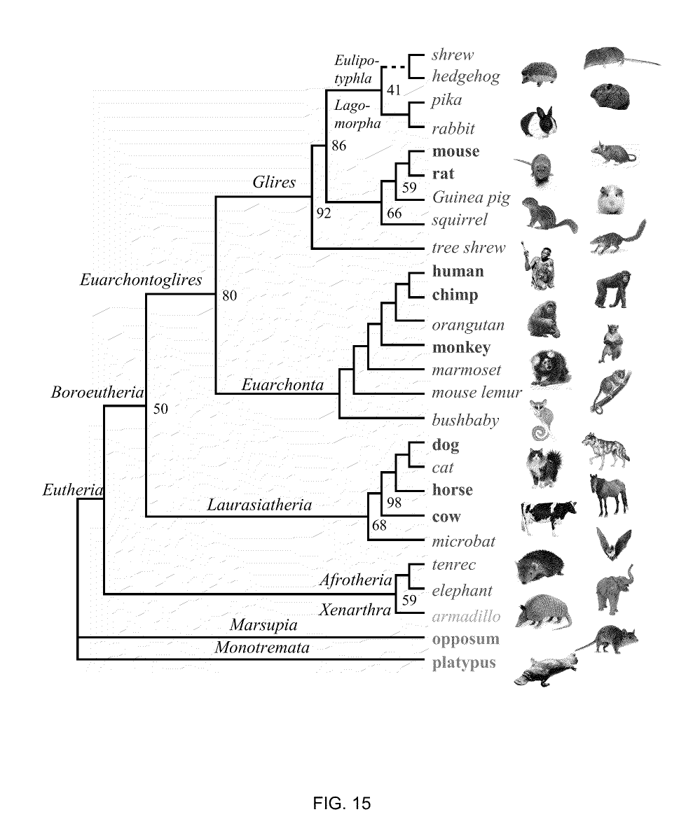

A jackknife validation test was used to access the robustness of the whole genome tree topology. All features for l=24, after filtering (˜2.5×10⁷ features) were randomly divided into 100 different subsets. Each subset of features is used to form an individually normalized feature frequency profile, a divergence matrix D is calculated for each subset of features, and then a neighbor joining tree is constructed. A consensus tree was then built from the forest of trees using CONSENSE (Felsenstein, J. (1989) Phylogeny Inference Package (Version 3.2) Cladistics, 5, 164-166) and extended majority rule. The support values are indicated in the internal nodes of FIG. 15. A leave-one-set-out (LOO) cross validation was also used, however all nodes had 99+ consensus scores. Thus, the above more stringent test-each-subset validation was used. Many of the features are redundant, by virtue of the sliding window frame used in the method, which explains the LOO results. FIG. 15 shows the following Clade groupings: Euarchontaglires (blue), Laurasiatheria (red), Afrotheria (green), Xenarthra (orange), non-Eutherian (grey). Support values are indicated at branch points. The tree shows support for the Atlantogenata hypothesis for Eutherian divergence. Lagomorpha (rabbits) and rodentia are monophyletic. Eulipotyphla (shrew+hedgehog) is found within glires, not Laurasiatheria. Bold faced genomes have greater than 10× sequencing depth, italicized are less than 5X survey genomes. The tree was produced with neighbor joining from D₁=₂₄ Jensen Shannon divergence information.

Clustering and Tree Building

The distance relationships between sequences, Dₗ, were examined using 2 methods: (a) (FIGS. 15 and 18) distance based tree building with neighbor joining, as implemented in PHYLIP (, J. (1989) Phylogeny Inference Package (Version 3.2) Cladistics, 5, 164-166 and (b) (FIGS. 16 and 17) Multidimensional Scaling (MDS) (Torgerson, W S (1952). Psychometrika, 17, 401-419) as implemented in the R environment (Ihaka, R, Gentleman, R. (1996) J. Comput. Stat. 5, 299-314).

Conclusion

A whole genome comparison, including both the genic and non-genic sequence, is representative of the whole genome divergence, which may reflect the divergence of organism better than methods based on selected genes. The latter are subject to sampling effects which can lead to biased results supporting a specific gene phylogeny rather than organism phylogeny. From the FFP comparison, the trees reconstructed using FFP are bush-like—which is consistent with the hypothesis of a rapid mammalian radiation.

Non-coding (non-exonic) sequences such as inter-genic regions and introns contain evolutionary phylogenic signal. The signal from non-genic (the whole genome minus the exonic, intronic, and regulatory regions) sequences of mammals on a whole genome scale is very similar to the evolutionary signal present in exonic and genic regions.

The current FFP method has the ability to analyze rare genomic changes such as indels and retroposon insertions. These events constitute a significant portion of the evolutionary signal present in mammalian genomes.

The phylogenies of the whole genomes and each of the component classes have similar topologies and all agree well with the evolutionary phylogeny based on a recent large dataset, multi-species, multi-gene based alignment. Additionally, the FFP genome comparison methods can account for rare genomic changes, such as indels and retroposon insertions, in calculating genome-scale distances.

### EXAMPLE 2

### Whole Proteome Phylogeny of Large dsDNA Virus Families by an Alignment-Free Method

Phylogenetic and taxonomic studies of viruses have become increasingly important as more and more whole viral genomes are sequenced (1-4). Knowledge of viral taxonomy and phylogeny is not only useful for understanding the diversity and evolution of viruses not only within a viral family, but also among different viral families that may have a common origin (5). They also provide useful information in drug design against virally induced diseases (6).

One of the unusual aspects of viral genomes is that they exhibit high sequence divergence due to high mutation rate, genetic recombination, re-assortment, horizontal gene transfer (HGT), gene duplication, and gene gain/loss (7, 8). A direct consequence of the high sequence divergence and relatively small number of genes in viruses is that the number of highly conserved genes among different viral families is very small or, sometimes, undetectable. For example, the relationship among different families of eukaryote large DNA viruses (LDV) has often been studied based on multiple sequence alignment of a single gene, the DNA polymerase gene (9). Whether this single-gene based analysis can be used to properly infer viral species phylogeny is debatable.

Due to this and other limitations of multiple sequence alignment comparison of one or a few selected viral genes, there has been a growing interest in alignment-free methods for whole genome comparison and phylogenomic studies. For example, alignment-free approaches have been used in the reconstruction of virus genome trees for a few individual virus families and multiple virus families: The composition vector method was used to construct a genome tree for large dsDNA viruses. The average common substring approach was used for phylogenomic analysis of the reverse-transcribing viruses and the negative-sense ssRNA viruses; and tetranucleotide usage patterns were found useful for inferring phylogenomic relationship among bacteriophages and eukaryotic viruses. Besides genome trees, self-organizing maps have also been used to understand the grouping of viruses.

In the previous alignment-free phylogenomic studies using l-mer profiles, three important issues were not properly addressed: (a) the selection of the feature length, l, appears to be without logical basis; (b) no statistical assessment of the tree branching support was provided; (c) the effect of HGT on phylogenomic relationship was not considered. HGT in LDVs has been documented by alignment-based methods, but these studies have mostly searched for HGT from host to a single family of viruses, and there has not been a study of inter viral family HGT among LDVs.

To address these issues, the present invention provides an alignment-free method using feature frequency profiles (FFPs). The present invention uses the FFP method, supplemented by a novel HGT detection technique, to study the taxonomic grouping and phylogenomic relationship among subfamilies within each family, as well as phylogenomic relationship among 11 families of eukaryote large dsDNA viruses, including 4 dsDNA insect viruses which have not yet been assigned to any virus family by the International Committee on the Taxonomy of Viruses (ICTV). Altogether, 142 complete LDV proteomes from NCBI's non-redundant RefSeq database (Pruitt K D, Tatusova T, Maglott D R (2007) NCBI reference sequences (RefSeq): a curated non-redundant sequence database of genomes, transcripts and proteins. Nucleic Acids Res 35:D61-65) were analyzed.

Results on the whole proteome tree reconstruction are presented, including the choice of optimal feature length, and the identification of inter viral family HGT genes. In order to increase the sensitivity of the FFP method, two filtering schemes were applied: the filtering of HGT candidate genes and the filtering of low-complexity features. Next, the overall features of the LDV proteome tree and grouping of individual viral families are described showing possible the evolutionary relationship among the individual families of the LDV, and the differences between the FFP phylogeny and existing alignment-based phylogenies of several individual viral families. Finally, the FFP tree is compared to a previous published alignment-free analysis.

Optimal Feature Length

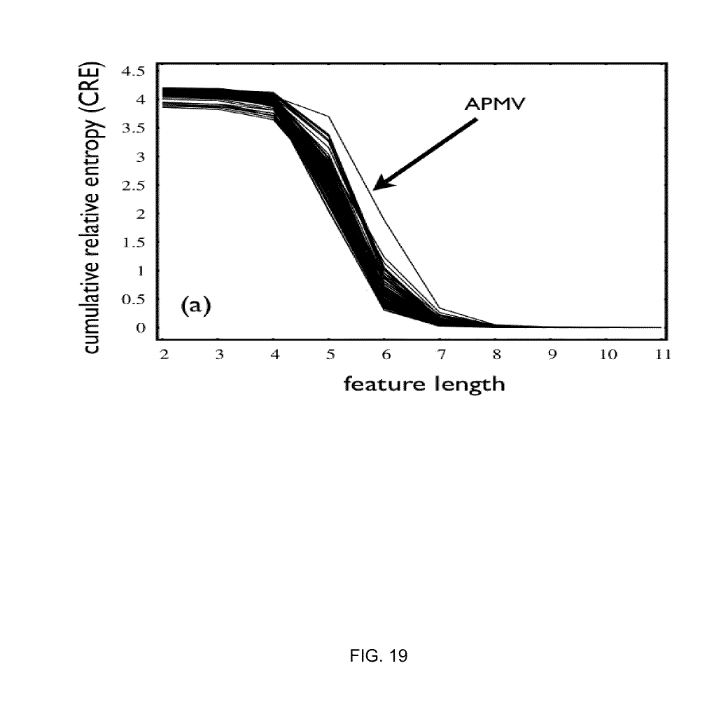

When whole genomes/proteomes are compared using l-mer FFP, different feature (l-mer) lengths can lead to different tree topologies. Thus, determining the optimal feature length is critical for obtaining a reliable tree topology. Based on both cumulative relative entropy (CRE) and relative sequence divergence (RSD) analyses, the optimal feature length for LDV proteomes is determined to be 8 amino acids long (see Materials and Methods). This estimate depends on the range of proteome size compared and the sequence divergence properties of the viruses, as shown in FIG. 19. FIG. 19 shows that the optimal feature length for whole proteome comparison and phylogeny inference is 8 and corresponds to when both CRE and RSD become much smaller than one.

Horizontal Rene Transfer Between Viral Families

The present invention uses the Jensen-Shannon divergence (JS) (Lin J (1991) Divergence measures based on the Shannon entropy. IEEE T Inform Theory 37:145-151.) of pair-wise FFPs to estimate the dissimilarity of 2 proteomes. JS provides a summary statistic of given FFP pairs (see Materials and Methods), and to a first approximation, is a measure of the fraction of the common features between two genomes. Thus, JS can be dominated by one or more unusually similar genes as they may contribute the most number of shared features, and this can distort the tree topology. For viruses from different families, such genes can be considered as candidates for inter-family HGT and should be removed before constructing FFPs. The inter-family gene transfer may be the result of a direct viral gene transfer between two viruses while co-infecting the same host, or when two viruses capture the same cellular gene from their phylogenetically related hosts in two separate events. In either case, it was assumed that HGT event occurred more recently compared to viral speciation, thus, the HGT genes have much higher sequence similarity compared to the rest of common genes between two compared viral families.

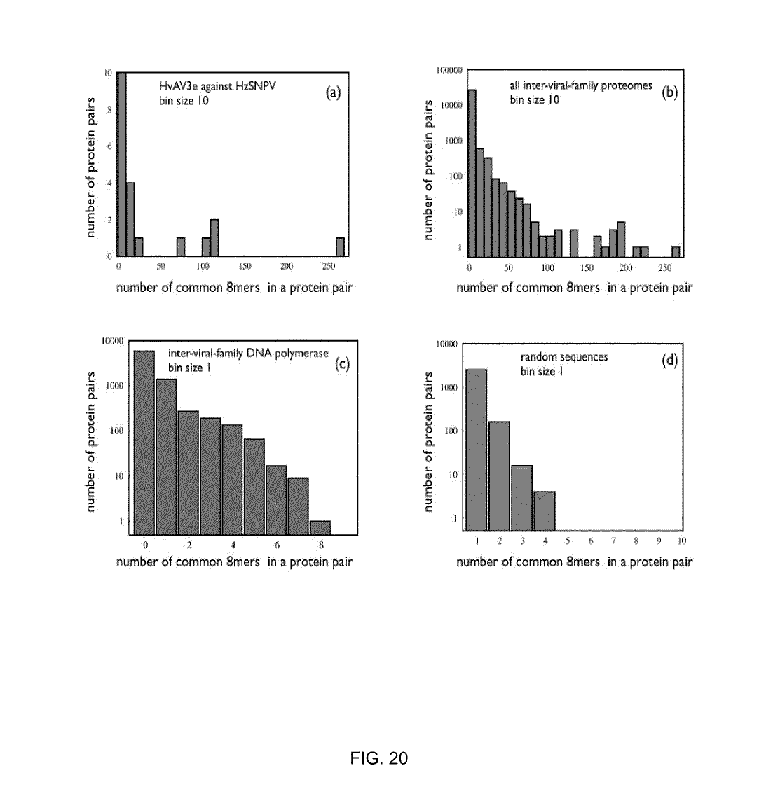

With our criteria for inter-family HGT detection, as shown in Material and Methods and FIG. 20, the total number of HGT instances is 164, consisting of 8 genes and distributed unevenly among viral families. Six of the 8 genes are present in the poxviridae family, and all six have cellular homologues. Some of these six genes have been suspected to be captured from hosts (Filee J, Pouget N, Chandler M (2008) Phylogenetic evidence for extensive lateral acquisition of cellular genes by Nucleocytoplasmic large DNA viruses. BMC Evol Biol 8:320, 22; Hughes A L, Friedman R (2005) Poxvirus genome evolution by gene gain and loss. Mol Phylogenet Evol 35:186-195). The remaining two (bro and hr genes) are present in the insect-infecting baculoviruses and ascoviruses, and do not seem to have cellular homologues. None of the eight genes is directly involved in the core viral activities of DNA replication and virus assembly. They are excluded in FFP calculations and tree reconstruction.

Low Complexity Feature Filtering

Low complexity features are those 8-mers consisting of one or very few types of amino acids. They generally bear no or little phylogenetic signal and may lead to misleading phylogeny if not removed in the proteome tree reconstruction. For the LDV proteomes, 8-mers with K₂<1.1 are filtered out (see Materials and Method).

The FFP Proteome Tree of LDV Superfamily

After deleting the HGT candidate proteins and filtering out the low complexity features, the whole proteome FFP tree is obtained for feature length 8 (FIG. 3). The invertebrate herpesvirus OsHV1 (the single member of Malacoherpesviridae) was used as the outgroup, as its proteome shows the greatest sequence divergence from the rest. A modified ootstrap resampling was used to estimate the robustness of the tree branching patterns (see Materials and Method). Most viral families form monophyletic groups with high statistical support. One exception is that the mimivirus is mixed within phycodnaviruses and the two families form a monophyletic group with a moderate statistical support. Furthermore, the FFP tree shows subfamiliy divisions within a viral family, some of them do not agree with current subdivisions (see below for individual families).

Relationship Among LDV Viral Families

A potential evolutionary relationship between families is also observed: The two families of iridovirus and ascovirus form a monophyletic group with high statistical support, in support of a gene-alignment based study (27); Nudivirus family is related to baculovirus family closer than to any other families of LDVs with a moderate support by the modified bootstrap method (see Phylgenetic tree building and robustness test in Materials and Methods); asfarvirus family is closer to poxvirus family than to any other families of LDVs with a relatively weak support. Finally, the above-mentioned six viral families form a large monophyletic group with moderate statistical support. It was also noticed that three herpes virus families (herpesviridae, alloherpesviridae and malacoherpesviridae) are not related phylgenetically (see Herpesviridae below).

In the following, the FFP phylogeny of individual viral families is compared to those based on alignment-based method.

Baculoviridae

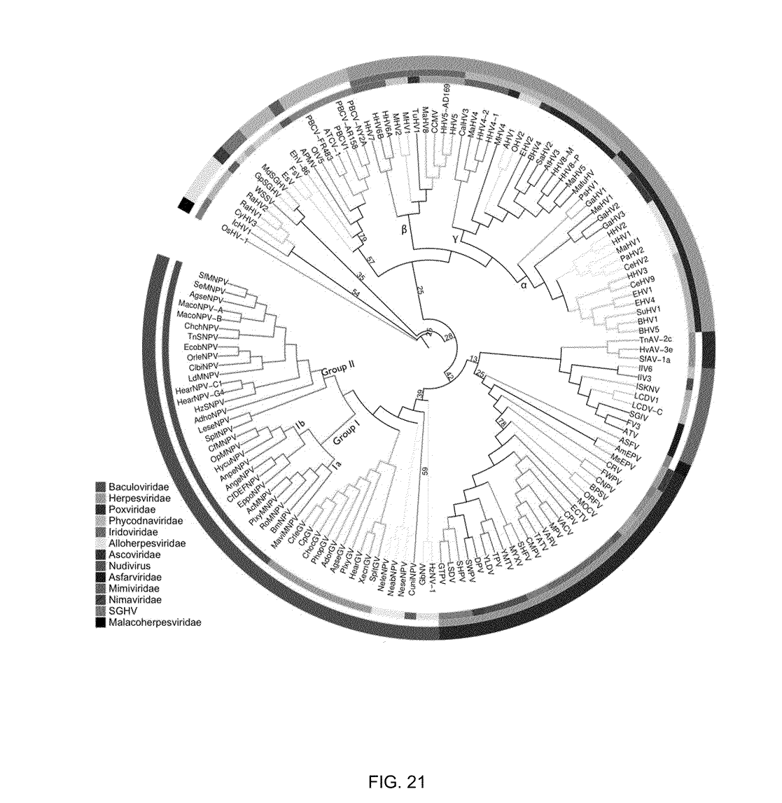

The grouping of baculoviruses in the FFP tree, as shown in the outer ring of FIG. 21, is consistent with the newly proposed four-genera classification (Jehle J A, et al. (2006) On the classification and nomenclature of baculoviruses: a proposal for revision. Arch Virol 151:1257-1266). Furthermore, the lepidopteran NPVs (shown in red in the inner ring of FIG. 3) can be divided into 2 monophyletic groups, the group I and group II NPVs, in agreement with a recent analysis based on sequence alignment of 29 core genes of Baculoviridae (1). In particular, AcMNPV clusters with PlxyMNPV, RoMNPV and BmNPV to form a froup, group I, in agreement with the 29 core gene analysis (1). This grouping is in conflict with the analysis based on the single polyhedrin gene, which assigns AcMNPV to group II. This conflict was shown to result from recombination in the AcMNPV polh gene (Jehle JA (2004) The mosaic structure of the polyhedrin gene of the Autographa californica nucleopolyhedrovirus (AcMNPV). Virus Genes 29:5-8). At an even finer resolution, the division of group I NPVs into clade 1a and clade 1b also agrees with the 29-gene analysis (Herniou E A, Jehle J A (2007) Baculovirus phylogeny and evolution. Curr Drug Targets 8:1043-1050). The remarkable agreement of the FFP-based baculovirus phylogeny with that of the 29-gene alignment-based analysis suggests that when a “large enough” number of genes are used, alignment-based and alignment-free methods converge for a given virus family. It is not clear what fraction of the genome/proteome can be considered “large enough” in alignment-based methods. Besides, when several viral families are compared simultaneously, no or very few conserved genes are common among them.

Herpesviridae

Herpesviruses are morphologically distinct from other viruses and they divide into 3 families under the recently established order Herpesvirales (Davison A J, et al. (2009) The order Herpesvirales. Arch Viral 154:171-177; McGeoch D J, Rixon F J, Davison A J (2006) Topics in herpesvirus genomics and evolution. Virus Res 117:90-104), namely Herpesviridae, Alloherpesviridae and Malacoherpesviridae. In the FFP tree, each family forms a clade, but the 3 families do not cluster to form a monophyletic group, indicating a lack of inter-family phylogenetic relationship at the genome sequence level despite morphological similarities. The Herpesviridae clade further divides into 3 monophyletic subgroups. as shown in the middle ring of FIG. 21, corresponding to the α,β and γ subfamilies with high statistical support. Of the three subfamilies, the β subfamily branches off first. This branching order is at variance with alignment-based analysis (31). The 4-member clade of the Alloherpesviridae shows moderate statistical support as a result of its great sequence divergence among the four viral proteomes, of which all but IcHV1 are currently not assigned at the genus level.

At the genus level, all except the Rhadinovirus genus, as shown in inner ring of FIG. 21, are monophyletic. FIG. 21 shows the FFP tree of large dsDNA viruses at feature length 8 after deleting horizontally transferred genes between viral families and filtering out low-complexity features. Modified bootstrap percentages less than 80% are shown and are based on 200 replicates. The tree is not drawn to scale. Outer circle color-codes 11 viral families as per ICTV and two groups of viruses not assigned to any family: nudivirus and saliva gland hypertrophy virus (SGHV) (See FIG. 21 legend at the bottom left.). The middle layer color-codes viral subfamilies of the poxviridae and herpesviridae. The different viral genera are color-coded by both the inner ring and tree leaves.Within the Rhadinovirus genus, the murid herpesvirus 4 (MHV4) proteome shows great sequence divergence and is separated from other members of the genus. Sequence alignment-based analysis also found that MHV4 has a particularly high level of sequence divergence, causing difficulties in determining its phylogenetic position unambiguously (32). The unclassified Tupaiid herpesvirus 1 (TuHV1) clusters with the Cytomegalovirus genus in the FFP tree, though it may or may not be assigned to the same genus.

Phycodnaviridae and Mimiviridae

There are nine phycodnaviruses and one mimivirus with complete proteomes in our data set. Each multi-member genus forms its own clade with high branch support. The recently sequenced marine green algae virus OtV5 (Derelle E, et al. (2008) Life-cycle and genome of OtV5, a large DNA virus of the pelagic marine unicellular green alga Ostreococcus tauri. PLoS ONE 3:e2250) is not yet included in the ICTV 2008 Official Taxonomy, though sequence comparison of the DNA polymerase gene suggested that it belong to the genus Prasinovirus. In the FFP tree, OtV5 is positioned next to the Chlorovirus genus, as is also the case with the DNA polymerase-based analysis.

The 9 phycodnaviruses do not form a monophyletic group in the FFP tree, because mimivirus, as shown in FIG. 21, nests within them, thus, all phycodnaviruses and the mimivirus together form a monophyletic group with moderate statistical support. Sequence alignment-based phylogeny using the major capsid protein or the DNA polymerase gene found similar mixing between the mimivirus and phycodnaviruses. This is at variance with an earlier phylogenetic analysis suggesting that the mimivirus form a separate family. In the FFP tree the mimivirus, the Chlorovrius genus, is most related to OtV5 among phycodnaviruses. Both the FFP tree and the recent sequence-alignment analyses reflect the high sequence divergences among the genera of Phycodnaviridae , especially of the genera Phaeovirus and Cocolithovirus, suggesting a possible taxonomic revision of the Phycodnaviridae family and of the mimivirus.

Poxviridae

The grouping of poxviruses in the proteome tree is consistent with the ICTV classification. The highly supported poxvirus clade falls into 2 monophyletic groups corresponding to the entomopoxvirinae and chordopoxvirinae subfamilies, and the latter further divides into three monophyletic groups associated with reptilian, avian and mammalian hosts, respectively. Each genus forms a clade in the FFP tree, and the branching order of different genera mostly agrees with an analysis based on alignment of a core set of 35 genes shared in the chordopoxvirinae subfamily (FIG. 21). Minor discrepancies in branching order are observed between the adjacent genera Leporipoxvirus and Yatapoxvirus and between the neighboring genera Capripoxvirus and Cervidpoxvirus.

In the FFP tree, the unclassified crocodile poxvirus is the outgroup of the chordopoxvirinae clade and positioned next to the Avipoxvirus genus. This suggests that the crocodile poxvirus could be assigned to a new genus within the chordopoxvirinae subfamily.

Other Viruses

There are four insect viruses that are not assigned to any viral family. Two of them (HzNV1 and GbNV) are nudiviruses and they form a clade and related closest to the baculovirus family in the FFP tree, consistent with an analysis based on alignment of the DNA polymerase gene. The other two insect viruses causing salivary gland hypertrophy (MdSGHV and GpSGHV) form a clade with high support in the FFP tree, corroborating a recent finding that the two are related and form a distinct clade based on analysis of gene trees. They are related closest to WSSV among LDV families. The FFP tree also suggests that the two nudiviruses and the two SGHVs be separately assigned to two new viral families.

Comparison with Another Alijnment-Free Method

In a previous report on the reconstruction of the whole proteome phylogeny of large dsDNA viruses (Gao L, Qi J (2007) Whole genome molecular phylogeny of large dsDNA viruses using composition vector method. BMC Evol Biol 7:41), the authors used an l-mer-based composition vector (CV) method with subtracted background ‘noise’ modeled by a Markov Chain estimator. Notable differences between the FFP tree and the CV tree are, 1) the CV tree was based on l-mers of length 5, but it was shown that the optimal feature length should be 8; 2) the CV tree did not explicitly deal with HGT among LDV families; 3) the authors did not provide statistical assessment of branch support in the CV tree; 4) neither baculoviruses nor iridoviruses are monophyletic in the CV tree; 5) the phycodnaviruses do not form a monophyletic group, with or without the mimivirus in the CV tree; and 6) ascoviruses were not included in the CV tree, which could further distort the CV tree topology due to the extensive HGT between ascovirus and baculovirus.

FFP Method vs Multiple Sequence Alignment (MSA) Method

MSA method has to select a small set of highly conserved genes for alignment, and has to assume that phylogeny of those selected genes represents the phylogeny of species. Thus, MSA method can be applied only within individual families or for families that are closely related, and the genes selected for MSA truly represent each species of the families. Therefore, MSA method can not be used for comparing a large population of diverse multiple families of LDVs. For inferring phylogeny of diverse families, FFP method has at least three advantages: (a) the whole genome/proteome is used to represent each species; (b) it does not require selection highly conserved genes common to all diverse families compared; and (c) it is not very sensitive to large-scale genome rearrangement and other changes including gene gain and loss.

Two points of interest about the optimal feature length for comparing viral whole proteomes—(a) On random statistical basis, one would predict that the probability of finding a unique 8-amino acid sequence in proteins is one in 20⁸, thus, each protein family in our collection of all proteins in LDVs has a unique 8-mer. It follows then that, if there is a common 8-mer between two proteomes, there must be a homologous protein in both viral species. This is true for two members in a virus species or two closely related viral species. For example, after excluding HGT genes and low complexity features, 95% of protein-pair from two closely related viruses (same family but different genera) that share the same 8-mer sequence are homologous with a blast E-value of 0.01 or lower. However, the prediction does not hold true for protein-pairs from two viruses of different families: for 50 type species representing all the LDV genera, it was found that only 53% protein-pairs from two viral families are homologous with a blast E-value of 0.01 or lower; (b) Even for two proteomes that share some common 8-mers, the profiles of the frequencies of all 8-mers are not same between the two proteomes. In addition to the advantages of FFP method mentioned in previous paragraph both points described here are important in understanding the clear difference between MSA method and FFP method.

Using the alignment-free FFP method of the present invention, the molecular phylogeny and horizontal gene transfer (HGT) between families for a broad population of large dsDNA eukaryote viruses consisting of eleven viral families were studied. The unique aspects of this study include: 1) the selection of feature length of l-mer optimal for phylogeny inference of the population; 2) a modified bootstrap support analysis of the branching orders in the FFP tree; and 3) identification of inter-family HGT candidate genes and exclusion of the genes from the FFP tree reconstruction. The analysis of the FFP tree for the broad population of LDVs suggests that the method is suitable for grouping diverse families of virues, subgrouping within individual families, finding possible evolutionary relationship among the families, and assigning “unclassified” species, even when there are no or few common genes among the broad population.

Materials and Methods

Dataset

The viral sequences were downloaded from NCBI's REFSEQ database (September 2008 release) (24). Protein sequences for large eukaryote dsDNA viruses are extracted from the .faa file. Polydnaviruses are excluded from consideration because they hardly share any common genes with other virus familiesThe final dataset of 142 LDVs consists of 11 viral families and 4 insect viruses unassigned to any family. The list of viruses is included as supplementary material.

Feature Frequency Profile (FFP) and Distance Matrix

The feature frequency profile of a given sequence is obtained by counting all overlapping features of length l by sliding a window of width l along the sequence, advancing one letter at a time. The FFP of a proteome is the total sum of the FFPs for each protein sequence contained therein. The present invention uses the normalized FFP, i.e. the probability of occurrence of each word in a proteome. The dissimilarity between two FFPs can be estimated from the Jensen-Shannon divergence (JS) (25). For two probability distributions P=(p₁, p₂, . . . ) and Q=(q₁, q₂, . . . ), JS is given by

$$JS ( P , Q ) = \frac{1}{2} KL ( P , \frac{P + Q}{2} ) + \frac{1}{2} KL ( Q , \frac{P + Q}{2} ) \qquad ( 1 )$$

where the KL(P,Q) is the Kullback-Leibler divergence (42) or relative entropy:

$$KL ( P , Q ) = {\sum }_{i} {p}_{i} {log}_{2} \frac{{p}_{i}}{{q}_{i}} \qquad ( 2 )$$

and the summation is over all features. Note that JS is bounded between 0 and 1. Strictly speaking, JS is not a distance metric, as it does not satisfy the triangle inequality relationship. However, this violation happens only for short feature lengths and is of no concern to us. For a given feature length l, the distance matrix for a collection of proteomes is constructed from all pair-wise JSs.

Relative Sequence Divergence (RSD), Cumulative Relative Entropy (CRE), and Optimal Feature Length

Since different feature lengths can lead to different tree topologies, it is important to know the optimal feature length for inferring reliable trees. Two methods exist for estimating the optimal feature length. The first is related to information theory and makes use of cumulative relative entropy (CRE) of individual proteomes. By contrast, the second method estimates the relative sequence divergence (RSD) of a proteome relative to a random sequence of the same size by comparing their relatedness (in terms of FFP) to a group of proteomes. Both methods give the same estimate for optimal feature length for the population of viruses in LDV superfamily.

CRE

This method estimates the minimal feature length for which the information content of a proteome can be approximated by its FFP. This is done by requiring the CRE between the FFP of a proteome and that of a Markov chain estimator to be small. Under a Markov chain model of order l−2, the expected l-mer frequencies of a sequence or proteome is given by frequencies of features of lengths l−1 and l−2 as follows,

$${\tilde{f}}_{{a}_{1} ⋯ {a}_{l}} = \frac{{f}_{{a}_{2} ⋯ {a}_{l}} * {f}_{{a}_{1} ⋯ {a}_{l - 1}}}{{f}_{{a}_{2} ⋯ {a}_{l - 1}}} \qquad ( 3 )$$

where f denotes observed feature-frequencies of a proteome, aᵢ denotes amino acid type at position i of a feature. The difference between the estimated and observed l-mer frequencies can be measured by the relative entropy KL(\tilde{P}ₗ,Pₗ), where \tilde{P}ₗ and Pₗ are estimated and observed probability vectors of l-mers respectively. This difference as a function of feature length exhibits a peak, whose position can be estimated using random sequences (zero order Markov chains) and is well approximated by

lₚₑₐₖ≅log₂₀N +1 (4)

where the base 20 is the number of amino acid types and Nis the proteome size.

A monotonically decreasing function can be constructed for the cumulative relative entropy (CRE),

$$CRE ( l ) = {\sum }_{i >= l} KL ( {\tilde{P}}_{i} , {P}_{i} ) \qquad ( 5 )$$

The minimal feature length at which CRE(l) approaches zero can be used iteratively to infer approximate frequencies of increasingly longer features, and is defined as the optimal feature length for phylogeny inference. For a group of divergent sequences like LDVs, this is approximately given by

l_{CRE}˜2log₂₀N (6)

where N denotes the largest proteome size. For LDVs, the largest proteomes (i e mimivirus and phycodnaviruses) give l_{CRE}≈8. This estimate is confirmed in FIG. 1(a), where CRE values from Eq. (5) are plotted for all LDVs against feature lengths, and they all approach zero at feature length 8, with the largest proteome of the mimivirus (APMV) as the main determining factor.

RSD

This method requires that on average, a biological sequence shares more features than a random sequence of the same length with a group of bio-sequences. For a group of n related biological sequences, the relative sequence divergence (RSD) for a biological sequence sᵢ with i=l . . . n can be defined as

$$RSD ( {s}_{i} ) = \frac{{\sum }_{j \neq i}^{ } c ( {r}_{i} , {s}_{j} )}{{\sum }_{j \neq i}^{ } c ( {s}_{i} , {s}_{j} )} \qquad ( 7 )$$

where c(sᵢ,sⱼ) denotes the number of common words between sequences sᵢ and sⱼ. rᵢ denotes a random sequence of zero order Markov chain with the same length as sᵢ. For short feature lengths (l<lₚₑₐₖ), nearly all possible features are used by both the random sequence and viral proteomes, and the RSD is around one. For longer feature lengths (l>lₚₑₐₖ), the feature space is sparsely sampled, with all the viral proteomes sampling one region and the random sequence a different region. As feature length increases, the overlap in feature space between the viral proteomes and random sequence becomes smaller and the RSD decreases to zero. Optimal feature length for phylogeny inference is obtained when RSD becomes much smaller than one.

In FIG. 19(b), the RSD's are plotted for four representative LDV proteomes including the smallest (NeleNPV), the largest (APMV), and intermediate (SHFV and CNPV), and they all fall below 0.05 at feature length 8 and longer. Thus both RSD and CRE analyses give l=8 as the optimal feature length of the LDV proteomes. With longer feature lengths, RSD and CRE become even smaller, but the average number of shared features between viral proteomes (especially distantly related ones) becomes fewer and the resulting tree topology is less robust.

Inter-Family HGT Candidates

HGT between viral families can cause some distortion of the tree topology, because JS can be biased by the few highly similar genes shared between two viruses as measured by the number of common 8-mers. For LDV proteomes at the optimal feature length l=8, the distribution of common 8-mers in a protein pair is illustrated in FIG. 20. FIG. 20 shows the number of protein pairs vs the number of common 8-mers in a protein pair between the large dsDNA virus proteomes from different viral families. FIG. 20(a) shows the ascovirus HvAV3e proteome against the baculovirus HzSNPV proteome. FIG. 20(b) shows inter-viral-family protein pairs from all proteomes. FIG. 20(c) shows inter-viral-family DNA polymerase pairs. FIG. 20(d) is the same as FIG. 20(b) but with each protein sequence subject to random permutation of its amino acids. Inter-family HGT candidates are identified when a protein pair shares usually high number of common 8-mers relative to both the random sequences and the DNA polymerase. In particular, FIG. 20(b) shows the results from pair-wise comparison of all proteins from different viral families, and FIG. 2(d) shows the same comparison after the amino acids in each protein sequence are randomly permuted. From FIG. 20(d), it was inferred that a protein-pair from our dataset can share up to four different 8-mers by chance. FIG. 20(c) plots the number of common 8-mers from DNA polymerase pairs between families, and the maximum number of shared 8-mers for the conserved DNA polymerase is 8. Thus, a protein pair from different viral families that share unusually high number of 8-mers relative to the random sequence and the DNA polymerase protein are candidates for HGT. For example, as shown in FIG. 20(a), the unusually large number of common 8-mers present in protein pairs from the ascovirus HvAV3e and the baculovirus HzSNPV suggests direct or indirect HGT events between the two viruses. In either case, it was assumed that the HGT event occurred more recently compared to viral speciation, thus, the HGT genes have much higher sequence similarity in terms of number of common 8-mers compared to the rest of common genes between two viral families.

To see the effect of using different HGT cutoffs (i.e. number of shared 8-mers) on LDV phylogeny, tree topologies with cutoffs ranging from 6 to 40 were compared. It was observed that the tree topology remains stable for a HGT cutoff in the range 13-31 (data not shown). For this work, a conservative HGT cutoff of 20 was used, and identified 164 HGT instances consisting of 8 genes (Suppl. Table S1). One hundred sixty four proteins coded by 8 HGT genes are excluded in the construction of the FFP proteome tree.

Filtering Out Low Complexity Features

These features generally bear no or little phylogenetic signal and could distort the tree topology if enough of them are present in the viral proteomes. One measure of feature complexity is the Shannon entropy

$${K}_{2} = - {\sum }_{i} \frac{{n}_{i}}{l} {log}_{2} \frac{{n}_{i}}{l} \qquad ( 8 )$$

where i runs over the 20 amino acid types, nᵢ is the occurrence frequency of amino acid type i in a given feature, and l is the feature length. This and another closely related complexity measure Kᵢ were used to detect and exclude regions of low complexity in amino acid sequences (44) during sequence alignment. For 8-mers, K₂ takes on values between 0 and 3, corresponding to using 1 and 8 amino acid types respectively.

The effect of using different low complexity cutoffs on phylogenetic tree reconstruction is noted but not shown. Excluding only the least complex features (i.e. homo 8-mers) causes appreciable change in the tree topology. For K₂ between 0 and 1.5, it was observed that the tree topology is most stable for cutoffs 0.9, 1.1 and 1.3. Based on this analysis, 8-mer features with K₂<1.1 were filtered out. These features account for 0.3% of the viral proteomes on average, and up to a maximum of 2% for the EhV86 proteome. By way of comparison, for random sequences with equal usage of different amino acid types, the fraction of 8-mers with K₂<1.1 is less than 10⁻⁵. The compositional types of these low complexity features include A₈, AₓB₈₋ₓ (x=1-4), and A₆B₁C₁, where A, B and C denote different amino acid types.

Phylogenetic Tree Reconstruction and Robustness Test

Phylogenetic trees are constructed from distance matrices using BIONJ (Gascuel O (1997) BIONJ: an improved version of the NJ algorithm based on a simple model of sequence data. Mol Biol Evol 14:685-695). Robustness of the tree topology is estimated using a modified version of the bootstrap method (elsenstein J (1985) Confidence limits on phylogenies: an approach using the bootstrap. Evolution 39:783-791) which works as follows. A table is first constructed with each row representing one viral proteome and each column representing one feature present in a viral proteome. Each table element indicates the feature frequency in a proteome (zero if absent). The bootstrap is applied to the columns of the table except that columns that are re-drawn are treated as drawn only once (i.e. each column is either present or absent in the bootstrapped table). Thus, the re-sampled table has fewer columns but each feature maintains the same frequency as in the original table. This procedure is equivalent to a jackknife test deleting 1/e (i.e. 37%) of the features. A new distance matrix is then calculated for the re-sampled table. 200 replicates were used to estimate the branch support for the un-bootstrapped tree. For the LDV dataset, a significant proportion of the features are unique to only one proteome, and the resampling is expected to underestimate the branch support. This and other factors (Alfaro M E, Zoller S, Lutzoni F (2003) Bayes or bootstrap? A simulation study comparing the performance of Bayesian Markov chain Monte Carlo sampling and bootstrapping in assessing phylogenetic confidence. Mol Biol Evol 20:255-266.) were taken into consideration when making phylogenetic inferences. Trees are drawn using iTOL (Letunic I, Bork P (2007) Interactive Tree Of Life (iTOL): an online tool for phylogenetic tree display and annotation. Bioinformatics 23:127-128).

### Conclusion

The foregoing description and Examples detail certain preferred embodiments and describes the best mode contemplated by the inventors. It will be appreciated, however, that no matter how detailed the foregoing may appear in text, the present embodiments may be practiced in many ways and the present embodiments should be construed in accordance with the appended claims and any equivalents thereof.

The term “comprising” is intended herein to be open-ended, including not only the recited elements, but further encompassing any additional elements. The present examples, methods, and procedures are meant to exemplify and illustrate the invention and should in no way be seen as limiting the scope of the invention. Any patents and publications mentioned in this specification are indicative of levels of those skilled in the art to which the invention pertains and are hereby incorporated by reference to the same extent as if each was specifically and individually incorporated by reference

What is claimed is:

1. A computer implemented method for comparing digital linear information, comprising:
providing a database of data to be compared, wherein the data is stored in individual objects in a linear form;
preprocessing of the object by removing all punctuation and delimiting characters;
reducing the object to a linear string of data;
applying a sliding window to the string of data to extract and count features of a given length;
assembling feature counts in the a feature frequency profile (FFP);
determining the best length feature for comparison;
comparing the FFPs of optimal length features using a distance metric;
assembling the distances between objects into a symmetric pair-wise distance matrix; and
visualizing the distance matrix.

2. The method of claim 1 wherein the determining comprises finding the vocabulary feature profile and a cumulative relative entropy profile.

3. The method of claim 1 wherein, if the data in to be compared is a large biological sequence, the preprocessing further comprises converting the data to a reduced two letter alphabet for comparison.

4. The method of claim 1 wherein the providing further comprises filtering features of low complexity, high frequency and reverse complement matching

5. The method of claim 1 wherein the distance metric in the providing comprises the Jensen Shannon Divergence.

6. The method of claim 1 wherein the visualizing comprises using a tree building method.

7. A system for comparing digital linear information, comprising:
a storage comprising a set of data items to be related, wherein each data item comprises a plurality of terms;
a frame generator conFIG.d to generate a frame that selects a plurality of terms in said data items to associate;
a profile generator conFIG.d to generate feature frequency profiles to extract and count features of a given length within said frame, wherein the profile generator further comprises instructions for determination of the best length feature for comparison;
a distance processor conFIG.d to compare the optimal best length features and assemble the distances between the objects into a pair-wise distance matrix; and
a visualization module to visualize the distance matrix.

8. The system of claim 7 wherein the distance processor is carried out on a multiprocessor computing device.

9. The method of claim 1 wherein the visualizing comprises using a dimension reduction algorithm.
